(19) United States
(12) Patent Application Publication
(10) Pub. No.: US 2013/0188719 A1
(43) Pub. Date: Jul. 25, 2013

(54) MOTION PREDICTION IN SVC USING MOTION VECTOR FOR INTRA-CODED BLOCK

(71) Applicant: Qualcomm Incorporated, San Diego, CA (US)

(72) Inventors: Ying Chen, San Diego, CA (US); Marta Karczewicz, San Diego, CA (US)

(73) Assignee: Qualcomm Incorporated, San Diego, CA (US)

(21) Appl. No.: 13/744,327

(22) Filed: Jan. 17, 2013

Related U.S. Application Data
(60) Provisional application No. 61/589,087, filed on Jan. 20, 2012.

(51) Int. Cl. H04N 7/26

(52) U.S. Cl. CPC H04N 19/00684
USPC 375/240.16

(57) ABSTRACT

Systems, methods, and devices for coding video data are described herein. In some aspects, a memory unit is configured to store the video data. The video data may include a base layer and an enhancement layer. The base layer may include a base layer coding unit co-located with a first enhancement layer coding unit in the enhancement layer. A processor may be configured to construct one or more motion vectors based at least in part on one or more base layer motion vectors available at the co-located base layer coding unit. The one or more motion vectors may be associated with the first enhancement layer coding unit. The processor may also be configured to determine pixel values of a neighbor enhancement layer coding unit based at least in part on the one or more motion vectors.

### CROSS-REFERENCE TO RELATED APPLICATIONS

This application claims priority under 35 U.S.C. §119(e) to U.S. Provisional Patent Application No. 61/589,087, entitled “PERFORMING MOTION PREDICTION IN SCALABLE VIDEO CODING” and filed on Jan. 20, 2012, the entire contents of which disclosure is herewith incorporated by reference.

### TECHNICAL FIELD

This disclosure relates to video coding and, more specifically, scalable video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information by implementing such video coding techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which may be quantized. The quantized transform coefficients may be initially arranged in a two-dimensional array and scanned in order to produce a one-dimensional vector of transform coefficients, and entropy coding may be applied to achieve even more compression.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of the disclosure provides an apparatus configured to code video data. The apparatus comprises a memory unit configured to store the video data. The video data may comprise a base layer and an enhancement layer. The base layer may comprise a co-located base layer coding unit. The enhancement layer may comprise a first enhancement layer coding unit and a neighbor enhancement layer coding unit. The first enhancement layer coding unit may be intra-mode coded. The neighbor enhancement layer coding unit may be inter-mode coded. The first enhancement layer coding unit may neighbor the neighbor enhancement layer coding unit. The co-located base layer coding unit may be located at a position in the base layer corresponding to a position of the first enhancement layer coding unit in the enhancement layer. The apparatus further comprises a processor in communication with the memory unit. The processor may be configured to construct one or more motion vectors based at least in part on one or more base layer motion vectors available at the co-located base layer coding unit. The one or more motion vectors may be associated with the first enhancement layer coding unit. The processor may also be configured to determine pixel values of the neighbor enhancement layer coding unit based at least in part on the one or more motion vectors.

Another aspect of the disclosure provides a method of coding video data. The method comprises retrieving video data from a memory unit. The video data may comprise a base layer and an enhancement layer. The base layer may comprise a co-located base layer coding unit. The enhancement layer may comprise a first enhancement layer coding unit and a neighbor enhancement layer coding unit. The first enhancement layer coding unit may be intra-mode coded. The neighbor enhancement layer coding unit may be inter-mode coded. The first enhancement layer coding unit may neighbor the neighbor enhancement layer coding unit. The co-located base layer coding unit may be located at a position in the base layer corresponding to a position of the first enhancement layer coding unit in the enhancement layer. The method further comprises constructing one or more motion vectors based at least in part on one or more base layer motion vectors available at the co-located base layer coding unit. The one or more motion vectors may be associated with the first enhancement layer coding unit. The method further comprises determining pixel values of the neighbor enhancement layer coding unit based at least in part on the one or more motion vectors.

Another aspect of the disclosure provides an apparatus for coding video data. The apparatus comprises means for retrieving video data from a memory unit. The video data may comprise a base layer and an enhancement layer. The base layer may comprise a co-located base layer coding unit. The enhancement layer may comprise a first enhancement layer coding unit and a neighbor enhancement layer coding unit. The first enhancement layer coding unit may be intra-mode coded. The neighbor enhancement layer coding unit may be inter-mode coded. The first enhancement layer coding unit may neighbor the neighbor enhancement layer coding unit. The co-located base layer coding unit may be located at a position in the base layer corresponding to a position of the first enhancement layer coding unit in the enhancement layer. The apparatus further comprises means for constructing one or more motion vectors based at least in part on one or more base layer motion vectors available at the co-located base layer coding unit. The one or more motion vectors may be associated with the first enhancement layer coding unit. The apparatus further comprises means for determining pixel values of the neighbor enhancement layer coding unit based at least in part on the one or more motion vectors.

Another aspect of the disclosure provides a non-transitory computer-readable medium comprising code that, when executed, causes an apparatus to retrieve video data from a memory unit. The video data may comprise a base layer and an enhancement layer. The base layer may comprise a co-located base layer coding unit. The enhancement layer may comprise a first enhancement layer coding unit and a neighbor enhancement layer coding unit. The first enhancement layer coding unit may be intra-mode coded. The neighbor enhancement layer coding unit may be inter-mode coded. The first enhancement layer coding unit may neighbor the neighbor enhancement layer coding unit. The co-located base layer coding unit may be located at a position in the base layer corresponding to a position of the first enhancement layer coding unit in the enhancement layer. The medium further comprises code that, when executed, causes an apparatus to construct one or more motion vectors based at least in part on one or more base layer motion vectors available at the co-located base layer coding unit. The one or more motion vectors may be associated with the first enhancement layer coding unit. The medium further comprises code that, when executed, causes an apparatus to determine pixel values of the neighbor enhancement layer coding unit based at least in part on the one or more motion vectors.

### BRIEF DESCRIPTION OF DRAWINGS

FIG. 1 is a diagram illustrating a graph having three dimensions reflective of the scalabilities that scalable video coding (SVC) enable.

FIG. 2 is a diagram illustrating an example of a SVC coding structure.

FIG. 3 is a diagram illustrating exemplary SVC access units in a bitstream.

FIG. 4 is a conceptual diagram illustrating an example of blocks in multiple layers in SVC.

FIG. 5 is a block diagram illustrating an example video encoding and decoding system that may utilize techniques in accordance with aspects described in this disclosure.

FIG. 6A is a table illustrating a detailed syntax table for a CU syntax.

FIG. 6B is a table illustrating a detailed syntax table for a PU syntax.

FIG. 7 is a diagram illustrating candidate coding units with respect to current coding unit.

FIG. 8 is a diagram illustrating spatial candidate scanning used in performing normal motion vector prediction.

FIG. 9 is a diagram illustrating an example of deriving a spatial motion vector predictor (MVP) candidate for a B-slice with a single reference picture list.

FIG. 10 is a block diagram illustrating an example of a video encoder that may implement techniques in accordance with aspects described in this disclosure.

FIG. 11 is a block diagram illustrating an example of a video decoder that may implement techniques in accordance with aspects described in this disclosure.

FIG. 12 is a block diagram illustrating a higher level layer and a lower level layer operating in a joint texture and motion prediction mode.

FIG. 13 is a table illustrating exemplary syntax defined for a coding unit in the INTRA_BL mode.

FIG. 14 is a diagram illustrating an exemplary structure of an LCU in a lower level layer and a CU in a higher level layer.

FIG. 15 is a table illustrating name associations for prediction mode and partitioning type.

FIG. 16 is a table illustrating the CU syntax elements for a new partition mode.

FIG. 17 is a table illustrating a current syntax design.

FIG. 18 is a block diagram illustrating a higher level layer and a lower level layer for PU to PU prediction.

FIG. 19 illustrates an example method for coding video data.

FIG. 20 is a functional block diagram of an example video coder.

FIG. 21 illustrates another example method for coding video data.

FIG. 22 is another functional block diagram of an example video coder.

FIG. 23 illustrates another example method for coding video data.

FIG. 24 is another functional block diagram of an example video coder.

### DETAILED DESCRIPTION

The techniques described in this disclosure are generally related to scalable video coding (SVC). For example, the techniques may be related to, and used with or within, a High Efficiency Video Coding (HEVC) scalable video coding (SVC) extension. In SVC, there can be multiple layers. A layer at the very bottom level or lowest level may serve as a base layer (BL), and the layer at the very top may serve as an enhanced layer (EL). The “enhanced layer” may be considered as being synonymous with an “enhancement layer,” and these terms may be used interchangeably. Layers between the BL and EL may serve as either or both ELs or BLs. For instance, a layer may be an EL for the layers below it, such as the base layer or any intervening enhancement layers, and also serve as a BL for an enhancement layers above it.

For purposes of illustration, the techniques described in the disclosure are described using examples where there are only two layers. One layer can include a lower level layer or reference layer, and another layer can include a higher level layer or enhancement layer. For example, the reference layer can include a base layer or a temporal reference on an enhancement layer, and the enhancement layer can include an enhanced layer relative to the reference layer. It should be understood that the examples described in this disclosure extend to multiple enhancement layers as well.

Video coding standards can include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its SVC and Multiview Video Coding (MVC) extensions. A draft of MVC is described in “Advanced video coding for generic audiovisual services,” ITU-T Recommendation H.264, March 2010. In addition, HEVC is currently being developed by the Joint Collaboration Team on Video Coding (JCT-VC) of ITU-T Video Coding Experts Group (VCEG) and ISO/IEC Motion Picture Experts Group (MPEG). A draft of the HEVC standard, referred to as “HEVC Working Draft 7” is in document HCTVC-I1003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012. This document is herein incorporated by reference in its entirety.

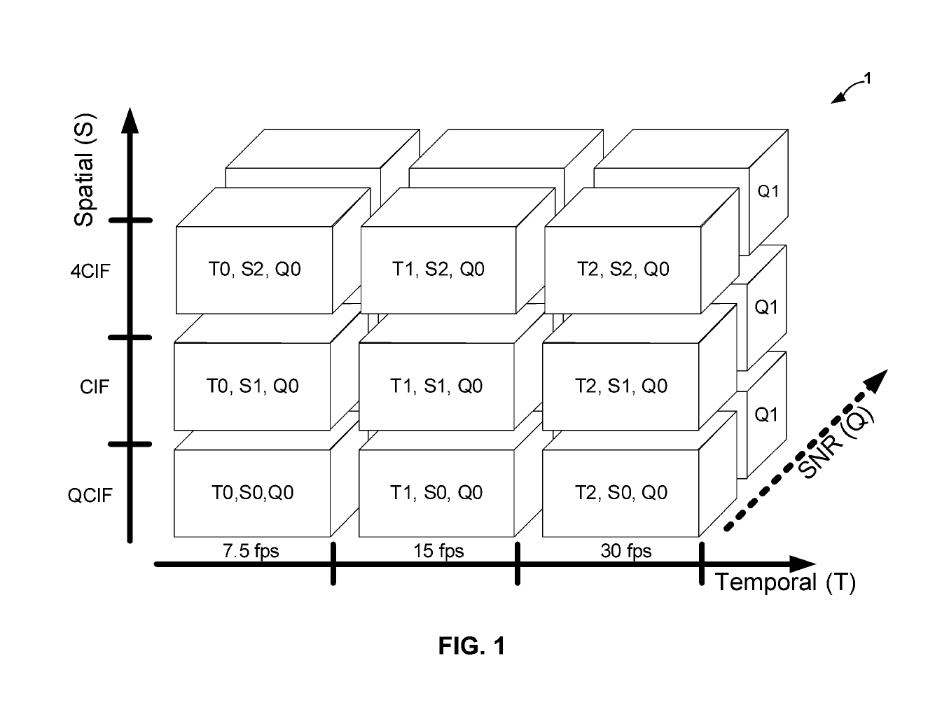

As an introduction to SVC, consider SVC as implemented with respect to the H.264/AVC standard. An example of scalabilities in different dimensions is shown in FIG. 1. FIG. 1 is a diagram illustrating a graph 1 having three dimensions reflective of the scalabilities that SVC enable. The three dimensions are: (1) the temporal (or time) dimension; (2) the spatial (or resolution) dimension; and (3) the signal-to-noise ratio (SNR) (or quality) dimension. In the temporal dimension, frame rates with 7.5 Hz, 15 Hz or 30 Hz can be supported by temporal scalability (T). When spatial (S) scalability is supported, resolutions of QCIF, CIF and 4CIF are enabled. For each specific spatial resolution and frame rate, the SNR (Q) layers can be added to improve the picture quality. Once the video content has been encoded in such a scalable way, an extractor tool may be used to adapt the actual delivered content according to application requirements, which are dependent, for example, on the clients or the transmission channel. In the example shown in FIG. 1, each cube shown with respect to graph 1 contains the pictures with the same frame rate (temporal level), spatial resolution, and SNR layers. Better representation can normally be achieved by adding those cubes (pictures) in any dimension. That is, a cube in the spatial dimension may be added to a cube directly below it to form a higher spatial resolution. Combined scalability (e.g., scalability in multiple dimensions and/or layers) is supported when there are two, three, or even more scalabilities enabled.

According to the SVC specifications, the pictures with the lowest spatial and quality layer are compatible with H.264/AVC, and the pictures in the lowest temporal level form the temporal base layer, which can be enhanced with pictures in higher temporal levels. In addition to the H.264/AVC compatible layer, several spatial and/or SNR enhancement layers can be added to provide spatial and/or quality scalabilities. SNR scalability is also referred to as quality scalability. Each spatial or SNR enhancement layer itself may be temporally scalable, with the same temporal scalability structure as the H.264/AVC compatible layer. For one spatial or SNR enhancement layer, the lower layer it depends on is also referred to as the base layer of that specific spatial or SNR enhancement layer.

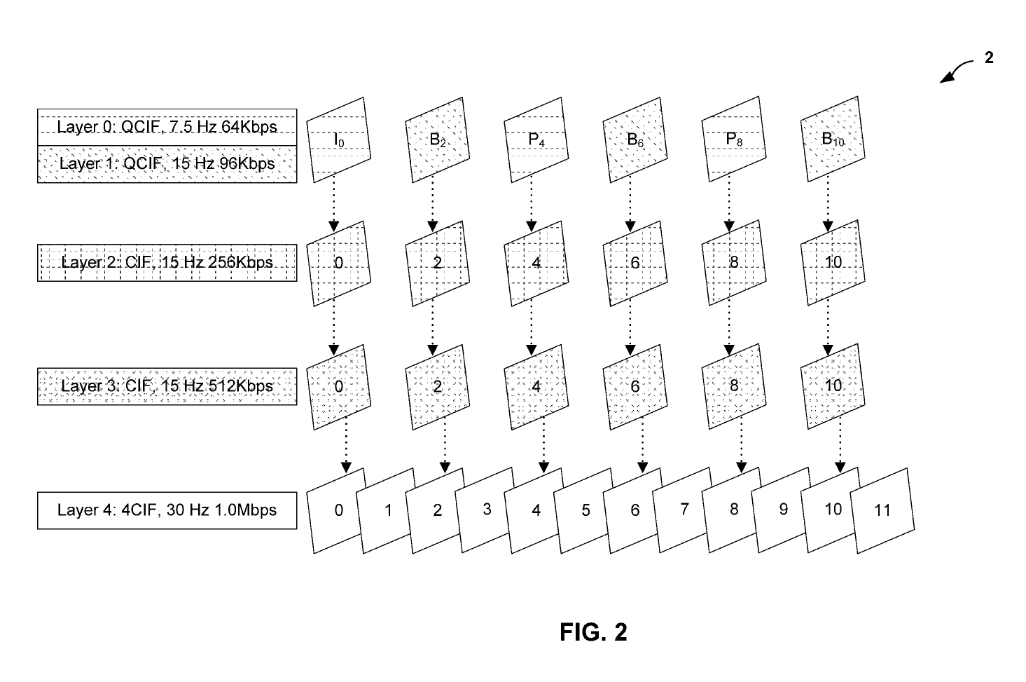

FIG. 2 is a diagram illustrating an example of a SVC coding structure 2. The pictures with the lowest spatial and quality layer (pictures in Layer 0 and Layer 1, with quarter common intermediate format (QCIF) resolution) may be compatible with H.264/AVC. Among them, those pictures of the lowest temporal level form the temporal base layer and are denoted as “Layer 0” in the example of FIG. 2. This temporal base layer (Layer 0) can be enhanced with pictures of higher temporal levels (Layer 1). In addition to the H.264/AVC compatible layer, several spatial and/or SNR enhancement layers can be added to provide spatial and/or quality scalabilities. For instance, the enhancement layer can be a common intermediate format (CIF) representation with the same resolution as Layer 2 of SVC coding structure 2. In the example of FIG. 2, Layer 3 may represent an SNR enhancement layer. As shown in the example, each spatial or SNR enhancement layer itself may be temporally scalable, with the same temporal scalability structure as the H.264/AVC compatible layer. Also, an enhancement layer (which is the general term for any layer that enhances the base layer whether the enhancement is in terms of the temporal, spatial or quality dimension) may enhance both spatial resolution and frame rate. For example, Layer 4 provides a 4CIF enhancement layer while also further increasing the frame rate from 15 Hz to 30 Hz.

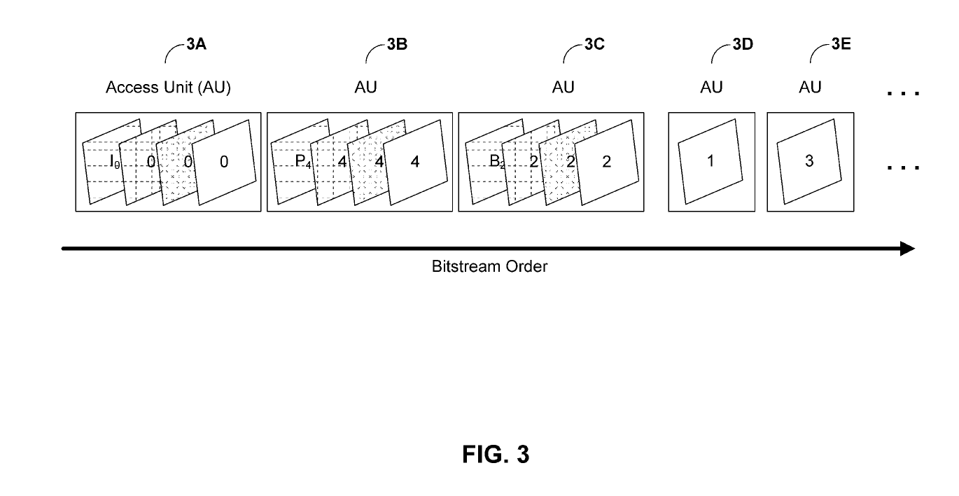

FIG. 3 is a diagram illustrating exemplary SVC access units 3A-3E in a bitstream. As shown in FIG. 3, the coded slices in the same time instance are successive in the bitstream order and form one access unit (e.g., access units 3A-3E (“access units 3”)) in the context of SVC. SVC access units 3 may then follow the decoding order (which could be different from the display order) decided, for example, by the temporal prediction relationships.

Some functionalities of SVC may be inherited from H.264/AVC. Compared to previous scalable standards, many aspects of SVC, such as hierarchical temporal scalability, inter-layer prediction, single-loop decoding, and flexible transport interface, may be inherited from H.264/AVC. Each of these aspects of SVC are described in more detail below.

As described herein, an enhanced layer may have different spatial resolution than a base layer. For example, the spatial aspect ratio between the EL and the BL can be 1.0, 1.5, 2.0, or other different ratios. In other words, the spatial aspect of the EL may equal 1.0, 1.5, or 2.0 times the spatial aspect of the BL. In some examples, the scaling factor of the EL may be greater than the BL. For example, a size of pictures in the EL may be greater than a size of pictures in the BL. Accordingly, the spatial resolution of the EL can be greater than the spatial resolution of the BL.

SVC introduces inter-layer prediction for spatial and SNR scalabilities based on texture, residue and motion. Spatial scalability in SVC has been generalized to any resolution ratio between two layers (e.g., any resolution ratio between the BL and the EL). SNR scalability can be realized by Coarse Granularity Scalability (CGS) or Medium Granularity Scalability (MGS). In SVC, two spatial or CGS layers belong to different dependency layers (indicated by dependency_id in network abstraction layer (NAL) unit header), while two MGS layers can be in the same dependency layer. One dependency layer includes quality layers with a quality_id syntax element ranging from 0 to higher values, where those values correspond to quality enhancement layers. In SVC, inter-layer prediction techniques may be utilized to reduce inter-layer redundancy.

For example, one exemplary inter-layer prediction technique involves inter-layer texture prediction. A coding mode using inter-layer texture prediction that is commonly referred to as an “IntraBL,” “INTRA_BL,” or “TEXTURE_BL” mode in SVC. To enable single-loop decoding, only the macroblocks (MBs) that have co-located MBs in the BL coded as constrained intra modes can use inter-layer texture prediction mode. A constrained intra mode MB refers to a MB that may be intra-coded (e.g., in other words, spatially coded) without referring to any samples from the neighboring MBs that are inter-coded (e.g., in other words, temporally coded).

Another exemplary inter-layer prediction technique involves inter-layer residual prediction, where an inter-coded MB in a BL is used for prediction of a co-located MB in the EL. A co-located MB in the EL is a MB located at a position in the EL that corresponds with a position of a MB in the BL. When an EL MB is encoded using this inter-layer residual prediction, the co-located MB in the BL for inter-layer prediction may be an inter MB and its residue may be upsampled according to the spatial resolution ratio. The residue difference between the EL and that of the BL may then be coded.

Another exemplary inter-layer prediction technique involves inter-layer motion prediction. In inter-layer motion prediction, the co-located BL motion vectors may be scaled to generate predictors for the motion vectors of a MB or a MB partition in the EL. In addition, there is one MB type named base mode, which sends one flag for each MB. If this flag is true and the corresponding BL MB is not intra-coded, the motion vectors, partitioning modes, and reference indices are all derived from BL.

In deriving the motion vectors at the BL, a fixed location, such as the top left 4×4 block within the BL MB, can be selected. The motion vectors at the fixed location can be used to generate the predictors for the motion vectors of the MB or the MB partition in the EL (e.g., the MB in the EL co-located with the MB in the BL). Further, one or more BL motion vectors used for EL prediction can be scaled according to the relation or ratio between the BL resolution and the EL resolution.

When motion vectors at the BL can be used to generate the predictors for the motion vectors of a current EL MB, there may be several locations that can be used to derive the motion vectors at the BL. For example, when the MB at the BL is larger than 4×4, there can be different motion vectors associated with each 4×4 area within the MB. In some embodiments, BL motion information (e.g., a motion vector, a reference index, an inter direction, etc.) can be obtained from the top left 4×4 block; however, this location may be less optimal than other locations in some instances.

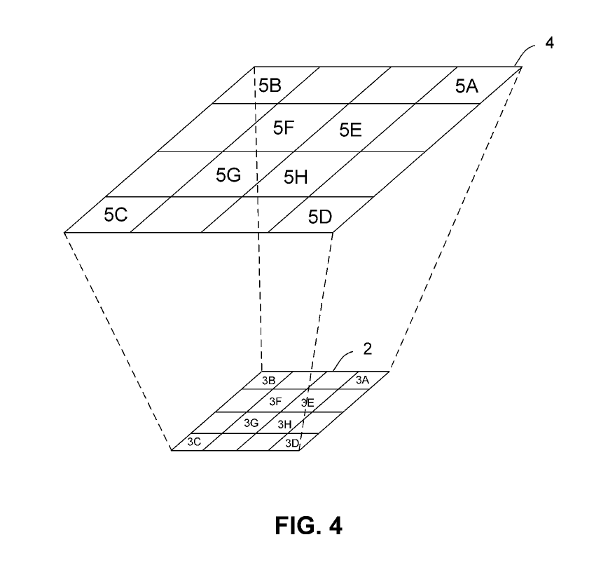

FIG. 4 is a conceptual diagram illustrating an example of blocks in multiple layers in SVC. For example, FIG. 4 illustrates a BL block 4 and an EL block 5, which may be co-located with one another such that the BL block 4 can be located at a position in the BL corresponding to the position of the EL block 5 in the EL.

BL block 4 includes sub-blocks 4A-4H, and EL block 5 includes sub-blocks 5A-5H. Each of sub-blocks 4A-4H may be co-located with each of sub-blocks 5A-5H, respectively. For example, each of sub-blocks 4A-4H may correspond to a respective one of sub-blocks 5A-5H. In some coders, the motion information from the top left sub-block (e.g., sub-block 4B) may be used to predict the motion information for EL block 5. However, this sub-block may be less optimal than other sub-blocks in some instances. In other coders, it may be desirable to use corners in the top right (e.g., sub-block 4A), bottom left (e.g., sub-block 4C), bottom right (e.g., sub-block 4D), center (e.g., one of sub-blocks 4E, 4F, 4G, 4H), or another of the sub-blocks inside co-located BL block 4.

In some embodiments, the location of the sub-block in the corresponding BL co-located block can be fixed and/or dependent on factors such as a largest coding unit (LCU), a coding unit (CU), a prediction unit (PU), transform unit (TU) sizes, an inter direction mode, a partition mode, an amplitude of motion vector or motion vector difference, a reference index, a merge flag, a skip mode, a prediction mode, a physical location of the base and EL blocks within the pictures, and the like. The LCU, CU, PU, and TU are described in greater detail below.

In some embodiments, the motion information can be derived jointly from two or more 4×4 sub-block locations inside the co-located BL block, using operations or functions such as an average, weighted average, median, and the like. For example, as shown in FIG. 4, five locations indicated with reference numerals 4A-4H may all be considered and the average or median value of their motion information (e.g., such as average or median values of x and y displacement values of the motion vectors) may be used as the motion information from co-located BL block in predicting EL motion information.

Alternatively or additionally, the techniques described in this disclosure can apply when information from the BL co-located block is used for prediction in coding subsequent blocks in the EL. For example, the reconstructed texture of the BL can be used as a predictor for the EL (e.g., IntraBL, INTRA_BL, or TEXTURE_BL mode). Under this mode, although motion information from a co-located BL block may not be used for coding the current block at the EL, the information may be inherited and used to populate the motion information of the current block at the EL and for prediction of motion information of a subsequent block in the EL, such as for Merge/advanced motion vector prediction (AMVP) list construction. The Merge mode and the AMVP mode are described in greater detail below. One or more (including all) of the techniques mentioned may be applicable in deriving the motion information from the BL. It should be noted that the INTRA BL mode provided herein is an example. The techniques described in this disclosure can apply in other scenarios, for example, such as in inter-layer residual prediction mode, inter-layer motion prediction mode, or other prediction modes.

In addition to motion information, the techniques described in the disclosure can apply to other type of information (e.g., other non-image information), including an intra-prediction mode, where intra-prediction mode of the co-located BL block may be inherited and used to predict the corresponding intra-prediction mode of the EL block. The corresponding locations may be signaled at the LCU/CU/PU level or header (e.g., at the slice, the sequence, the picture headers, etc.).

In some embodiments, a video encoder may receive non-downsampled, non-image information for a lower level layer block, and perform functions in accordance with one or more embodiments described in this disclosure. In addition, the video encoder can downsample non-image information of the BL block.

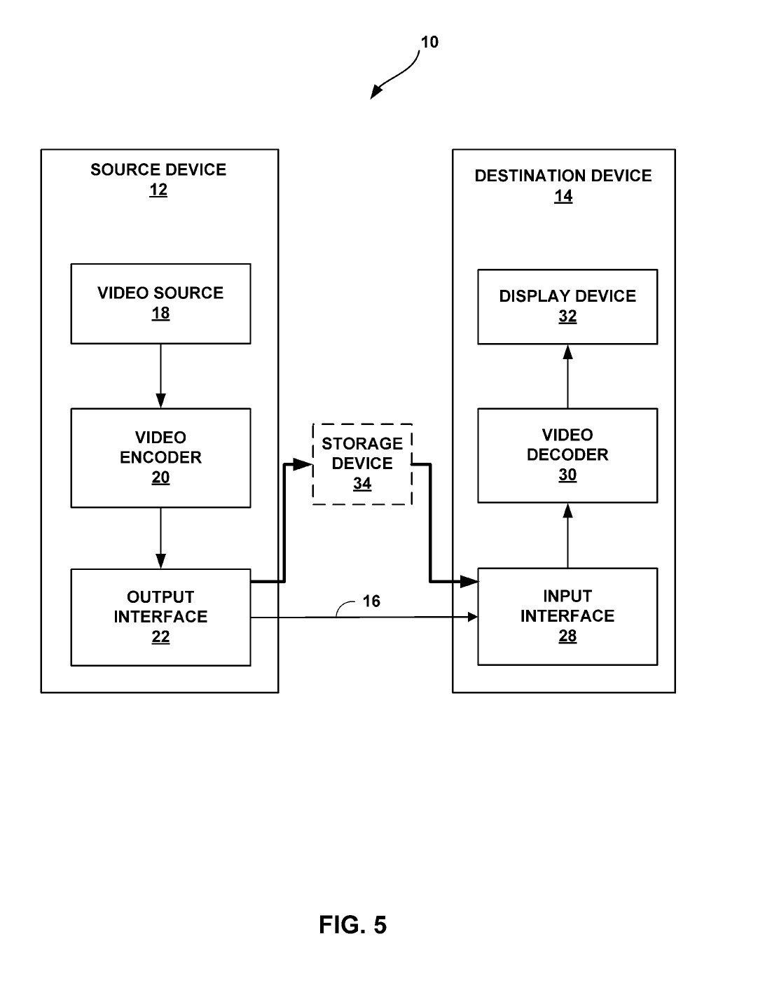

FIG. 5 is a block diagram illustrating an example video encoding and decoding system that may utilize techniques in accordance with aspects described in this disclosure. As shown in FIG. 5, system 10 includes a source device 12 that can provide encoded video data to be decoded by a destination device 14. In particular, source device 12 can provide the video data to destination device 14 via a computer-readable medium 16. Source device 12 and destination device 14 may include a wide range of devices, including desktop computers, notebook (e.g., laptop) computers, tablet computers, set-top boxes, telephone handsets, such as so-called “smart” phones, so-called “smart” pads, televisions, cameras, display devices, digital media players, video gaming consoles, video streaming device, or the like. Source device 12 and destination device 14 may be equipped for wireless communication.

Destination device 14 may receive the encoded video data to be decoded via computer-readable medium 16. Computer-readable medium 16 may comprise a type of medium or device capable of moving the encoded video data from source device 12 to destination device 14. For example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network, such as the Internet. The communication medium may include routers, switches, base stations, or other equipment that may be useful to facilitate communication from source device 12 to destination device 14.

In some embodiments, encoded data may be output from output interface 22 to an optional storage device 34. Similarly, encoded data may be accessed from the storage device 34 by input interface 28. The storage device 34 may include any of a variety of distributed or locally accessed data storage media, such as a hard drive, Blu-ray discs, DVDs, CD-ROMs, flash memory, volatile or non-volatile memory, or other digital storage media for storing video data. The storage device 34 may correspond to a file server or another intermediate storage device that may store the encoded video generated by source device 12. Destination device 14 may access stored video data from the storage device 34 via streaming or download. The file server may be a type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through a standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device 34 may be a streaming transmission, a download transmission, or a combination thereof.

The techniques of this disclosure can apply to applications or settings in addition to wireless applications or settings. The techniques may be applied to video coding in support of a variety of multimedia applications, such as over-the-air television broadcasts, cable television transmissions, satellite television transmissions, Internet streaming video transmissions (e.g., dynamic adaptive streaming over HTTP (DASH)), digital video that is encoded onto a data storage medium, decoding of digital video stored on a data storage medium, or other applications. In some embodiments, system 10 may be configured to support one-way or two-way video transmission to support applications such as video streaming, video playback, video broadcasting, and/or video telephony.

In FIG. 5, source device 12 includes video source 18, video encoder 20, and output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 34 for later access by destination device 14 or other devices, for decoding and/or playback.

Destination device 14 includes input interface 28, video decoder 30, and display device 32. In some cases, input interface 28 may include a receiver and/or a modem. Input interface 28 of destination device 14 receives the encoded video data over link 16. The encoded video data communicated over link 16, or provided on storage device 34, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device.

Video encoder 20 of source device 12 may be configured to apply the techniques for coding a bitstream including video data conforming to multiple standards or standard extensions. In other embodiments, a source device and a destination device may include other components or arrangements. For example, source device 12 may receive video data from an external video source 18, such as an external camera. Likewise, destination device 14 may interface with an external display device, rather than including an integrated display device.

System 10 of FIG. 5 is one example system, and techniques for determining candidates for a candidate list for motion vector predictors for a current block may be performed by other digital video encoding and/or decoding devices. Although generally the techniques of this disclosure can be performed by a video encoding device, the techniques can be performed by a combined video encoder/decoder, typically referred to as a “CODEC.” Moreover, the techniques of this disclosure can be performed by a video preprocessor. Source device 12 and destination device 14 are examples of such coding devices in which source device 12 generates coded video data for transmission to destination device 14. In some embodiments, devices 12 and 14 may operate in a substantially symmetrical manner such that each of devices 12 and 14 include video encoding and decoding components. Hence, system 10 may support one-way or two-way video transmission between video devices 12 and 14 (e.g., for video streaming, video playback, video broadcasting, or video telephony).

Video source 18 of source device 12 may include a video capture device, such as a video camera, a video archive containing previously captured video, and/or a video feed interface to receive video from a video content provider. Video source 18 may generate computer graphics-based data as the source video, or a combination of live video, archived video, and computer-generated video. In some embodiments, if video source 18 is a video camera, source device 12 and destination device 14 may form so-called camera phones or video phones. The captured, pre-captured, or computer-generated video may be encoded by video encoder 20. The encoded video information may be output by output interface 22 to a computer-readable medium 16.

Computer-readable medium 16 may include transient media, such as a wireless broadcast or wired network transmission, or storage media (e.g., non-transitory storage media), such as a hard disk, flash drive, compact disc, digital video disc, Blu-ray disc, or other computer-readable media. A network server (not shown) may receive encoded video data from source device 12 and provide the encoded video data to destination device 14 (e.g., via network transmission). A computing device of a medium production facility, such as a disc stamping facility, may receive encoded video data from source device 12 and produce a disc containing the encoded video data. Therefore, computer-readable medium 16 may be understood to include one or more computer-readable media of various forms.

Input interface 28 of destination device 14 can receive information from computer-readable medium 16. The information of computer-readable medium 16 may include syntax information defined by video encoder 20, which can be used by video decoder 30, that includes syntax elements that describe characteristics and/or processing of blocks and other coded units (e.g., a group of pictures (GOPs)). Display device 32 displays the decoded video data to a user, and may include any of a variety of display devices, such as a cathode ray tube (CRT), a liquid crystal display (LCD), a plasma display, a light emitting diode (LED) display, an organic light emitting diode (OLED) display, or another type of display device.

Video encoder 20 and video decoder 30 may operate according to a video coding standard, such as the HEVC standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263. Although not shown in FIG. 5, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a non-transitory computer-readable medium and execute the instructions in hardware using one or more processors to perform the techniques of this disclosure. Each of video encoder 20 and video decoder 30 may be included in one or more encoders or decoders, either of which may be integrated as part of a CODEC in a respective device. A device including video encoder 20 and/or video decoder 30 may comprise an integrated circuit, a microprocessor, and/or a wireless communication device, such as a cellular telephone.

The JCT-VC is working on development of the HEVC standard. The HEVC standardization efforts are based on an evolving model of a video coding device, referred to as the HM. The HM presumes several additional capabilities of video coding devices relative to existing devices according to, for example, the ITU-T H.264/AVC standard. For example, whereas H.264 provides nine intra-prediction encoding modes, the HM may provide as many as thirty-three intra-prediction encoding modes.

In general, the working model of the HM describes that a video sequence includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU, which is described in greater detail below. The video blocks may have fixed or varying sizes, and may differ in size according to a specified coding standard.

In this disclosure, “N×N” and “N by N” may be used interchangeably to refer to the pixel dimensions of a video block in terms of vertical and horizontal dimensions (e.g., 16×16 pixels or 16 by 16 pixels). In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As used herein, the term “block” refers to any of a CU, PU, or TU, in the context of HEVC, or similar data structures in the context of other standards (e.g., macroblocks and sub-blocks thereof in H.264/AVC). In addition, as used herein, the term “video block” refers to a coding node of a CU. In some specific cases, this disclosure may also use the term “video block” to refer to a treeblock (e.g., an LCU, or a CU that includes a coding node and PUs and TUs).

A video frame or picture may be divided into a sequence of treeblocks (e.g., coding trees or LCUs) that include both luma and chroma coding blocks. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into CUs according to a quadtree (e.g., each treebolock may be split into four CUs). A CU may be formed from a luma coding block, two chroma coding blocks, and associated syntax data. In general, a quadtree data structure includes one node per CU, with a root node corresponding to the treeblock. If a CU is split into four sub-CUs, the node corresponding to the CU includes four leaf nodes, each of which corresponds to one of the sub-CUs. Thus, a treeblock may be split into four child nodes (e.g., CUs), and each child node may in turn be a parent node and be split into another four child nodes (e.g., sub-CUs).

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split. Syntax data associated with a coded bitstream may define a maximum number of times a treeblock may be split (referred to as a maximum CU depth) and may also define a minimum size of the coding nodes (referred to as a smallest coding unit (SCU)).

A CU has a similar purpose as a MB of the H.264 standard, except that a CU does not have a size distinction. A CU includes a coding node. A size of the CU corresponds to a size of the coding node and must be square in shape. The size of the CU may range from 8×8 pixels up to the size of the treeblock, with a maximum of 64×64 pixels or greater.

Each leaf-CU may contain one or more PUs and one or more TUs. A PU describes a partition of a CU for the prediction of pixel values. Syntax data associated with a CU may describe, for example, partitioning of the CU into one or more PUs. Partitioning modes may differ between whether the CU is skip or direct mode encoded, intra-prediction mode encoded, or inter-prediction mode encoded. A PU may be square or non-square (e.g., rectangular) in shape.

In general, a PU represents a spatial area corresponding to all or a portion of the corresponding CU, and may include data for retrieving a reference sample for the PU. Moreover, a PU includes data related to the prediction process. For example, when the PU is intra-mode encoded, data for the PU may be included in a residual quadtree (RQT). The RQT may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or NxN. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

Following intra-predictive or inter-predictive coding using the PUs of a CU, video encoder 20 may calculate residual data for the TUs of the CU. The residual data may correspond to pixel differences between pixels of the unencoded (e.g., original) picture and prediction values corresponding to the PUs. A TU represents the units of a CU that are spatially transformed using a transform (e.g., a discrete cosine transform (DCT), an integer transform, a wavelet transform, or a conceptually similar transform). Syntax data associated with a CU may describe, for example, partitioning of the CU into one or more TUs. In some aspects, the CU may be partitioned into one or more TUs according to a quadtree. A TU may be square or non-square (e.g., rectangular) in shape.

The TUs may be specified using an RQT (also referred to as a TU quadtree structure), as discussed above. For example, a split flag may indicate whether a leaf-CU is split into four TUs. Then, each TU may be split further into sub-TUs. When a TU is not split further, it may be referred to as a leaf-TU.

Generally, for intra coding, all the leaf-TUs belonging to a leaf-CU share the same intra-prediction mode. That is, the same intra-prediction mode is generally applied to calculate predicted values for all TUs of a leaf-CU. For intra coding, video encoder 20 may calculate residual data for each leaf-TU using the intra-prediction mode. A TU is not necessarily limited to the size of a PU. Thus, a TU may be the same size, larger, or smaller than a PU. For intra coding, a PU may be co-located with a corresponding leaf-TU for the same CU. In some examples, the maximum size of a leaf-TU may correspond to the size of the corresponding leaf-CU.

As described above, the PUs may comprise syntax data describing a method or mode of generating predictive pixel data in the spatial domain (also referred to as the pixel domain). In addition, the TUs may comprise coefficients in the transform domain once a transform as described above is applied to the calculated residual data. For example, video encoder 20 may form the TUs by including the residual data, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector (e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology). Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and/or GOP-based syntax data, to video decoder 30 (e.g., in a frame header, a block header, a slice header, or a GOP header). The GOP-based syntax data may describe a number of frames in the respective GOP, and the frame-based syntax data may indicate an encoding/prediction mode used to encode the corresponding frame.

In accordance with the techniques of this disclosure, source device 12 and destination device 14 may be configured to receive original, non-downsampled information for a lower level layer block (e.g., a BL block), and predict information for a higher level layer block (e.g., an EL block) based on the original, non-downsampled information for the lower level layer block. In some examples, after predicting the information for the higher level layer block, source device 12 may downsample the information for the lower level layer block.

Source device 12 and destination device 14 may determine a location of a sub-block within the lower level layer block, and derive information from the sub-block within the lower level block. In this example, source device 12 and destination device 14 may predict information for the higher level layer block based on the derived information. The information may be motion information, intra-prediction mode, or other types of information (e.g., non-image information associated with blocks). The motion information may include a motion vector, a reference index, inter direction information, and/or the like.

The emerging HEVC working draft (WD) may be considered in view of the above discussion of H.264/AVC. In the HEVC WD, there are two modes for the prediction of motion parameters. One mode may be referred to as a “Merge mode,” while the other mode may be referred to as an “advanced motion vector prediction” mode or “AMVP mode.”

The Merge mode is similar to the AMVP mode, except that motion information for the current block may be inferred from motion information of neighboring blocks. In other words, Merge mode is a video coding mode in which motion information (e.g., motion vectors, reference frame indexes, prediction directions, or other information) of a neighboring video block are inherited for a current video block being coded. Unlike in the AMVP mode, the reference index may not be signaled by the source device 12 in the Merge mode. Rather, one of five neighbors may provide the motion information: a left top neighbor (e.g., the top-most left neighbor, also referred to as the left neighbor), a top left neighbor (e.g., the left-most top neighbor, also referred to as the top neighbor), a top right neighbor (e.g., the right-most top neighbor), a bottom left neighbor (e.g., the bottom-most left neighbor), or co-located block from a temporally adjacent frame (e.g., a block co-located with the center of the current block). A flag or index value may be used to identify the neighbor from which the current block inherits its motion information (e.g., top neighbor, top right neighbor, left neighbor, left bottom neighbor, or co-located block from a temporally adjacent frame).

In the AMVP mode, a list of motion vector predictors is created from spatial and/or temporal neighbors of a block that can be used for motion prediction. In other words, in motion vector prediction, the motion vector of a neighboring video block is used in the coding of a current video block. For example, blocks that spatially neighbor the current block to the top and to the left may provide motion vector predictors for the list. In addition, a co-located block that temporally neighbors the current block may also provide a motion vector predictor for the list. In some embodiments, predictive coding of motion vectors is applied to reduce the amount of data needed to communicate the motion vector. For example, rather than encoding and communicating the motion vector itself, the encoder encodes and communicates a motion vector difference (MVD) relative to a known (or knowable) motion vector. AMVP allows for many possible candidates for defining the MVD. In other embodiments, the predictors may be motion vectors from the spatial and/or temporal neighbors.

In an embodiment, both Merge and AMVP modes build a candidate list for reference picture list zero (e.g., RefPicList0 or List 0) and a candidate list for reference picture list one (e.g., RefPicList1 or List 1). In some embodiments, the Merge and/or AMVP modes also build a candidate list for reference picture list c (e.g., RefPicListC or List C). Each of these reference picture lists may be used for uni-directional or bi-directional prediction and specify a list of potential pictures or frames used for performing temporal and/or spatial motion prediction.

A candidate of AMVP to be used for the coding of motion parameters are from spatial and temporal neighboring blocks. In the AMVP mode, the reference index values are signaled. In an embodiment, in the AMVP mode, a first list (e.g., RefPicList0 or List 0) may include motion vector predictors from spatial neighbors to the top, a second list (e.g., RefPicList1 or List 1) may include motion vector predictors from spatial neighbors to the left, and a third list (e.g., RefPicListC or List C) may include a motion vector predictor from a temporal neighbor.

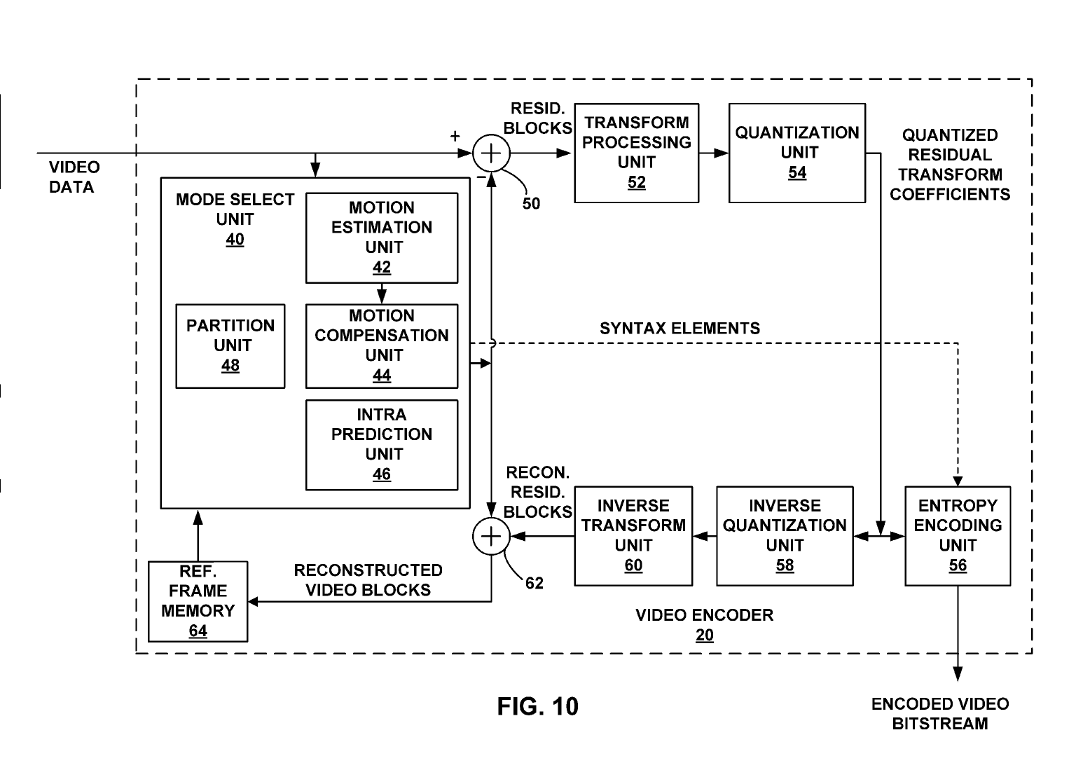

In an embodiment, in the AMVP mode, the source device 12 (e.g., the motion estimation unit 42 of the video encoder 20, as described below with respect to FIG. 10) may select one motion vector predictor from a block in the group of blocks that spatially neighbor the current block to the top based on motion information. For example, the motion vector predictor of a block may be chosen if the motion vector in the block points to the same reference picture as the current block. If all the blocks in the group have been analyzed and none of the motion vectors point to the same reference picture as the current block, the motion vector of the last block analyzed may be scaled. The motion vector may be scaled based on the picture order count (POC) distance between the current picture and the reference picture of the last analyzed block and the POC distance between the current picture and the reference picture of the current block. The source device 12 may select one motion vector predictor of a block in the group of blocks that spatially neighbor the current block to the left in the same manner. Once a motion predictor vector has been selected from the group of blocks that spatially neighbor the current block to the top and from the group of blocks that spatially neighbor the current block to the left, the source device 12 (e.g., the video encoder 20) may then select one of the final three motion vector predictors (e.g., the motion vector predictor from the block that spatially neighbors the current block to the top, the motion vector predictor from the block that spatially neighbors the current block to the left, and the motion vector predictor from the block that temporally neighbors the current block). A reference index may be signaled (e.g., transmitted by the source device 12 via the computer-readable medium 16 or included in the encoded video bitstream as described below) to indicate which of the final three motion vector predictors was selected and that should be used when decoding. If one of the three motion vector predictors is not available (e.g., because the neighboring blocks are intra-coded, and thus have no motion information), then the source device 12 chooses from fewer than three motion vector predictors.

In the Merge mode, reference index values are not signaled since the current PU shares the reference index values of the chosen candidate motion vector predictor. In some instances, the Merge mode may be implemented such that only one candidate list is created.

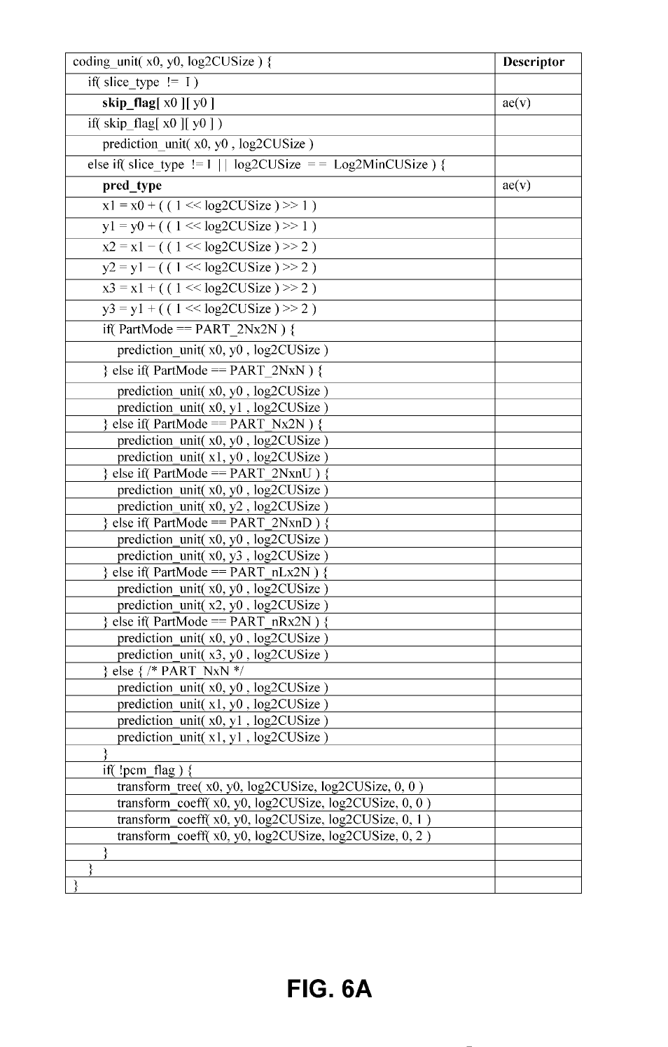

FIGS. 6A-B illustrate detailed syntax tables that define the current HEVC WD syntax elements for a CU (which may be similar to a block in H.264/HEVC in some aspects) and a PU (which stores prediction information, such as the reference picture lists, the selected reference picture, the motion vector predictors, etc.). In particular, FIG. 6A illustrates a detailed syntax table for a CU syntax and FIG. 6B illustrates a detailed syntax table for a PU syntax. In the Merge mode, the Merge_idx syntax element may be used to choose a candidate from the lists created when the merge mode is employed and mvp_idx_l0, mvp_idx_l1 and mvp_idx_lc are used to choose candidates from a list created when the AMVP mode is employed. The number of entries in the list or lists for the Merge mode and the AMVP mode is fixed.

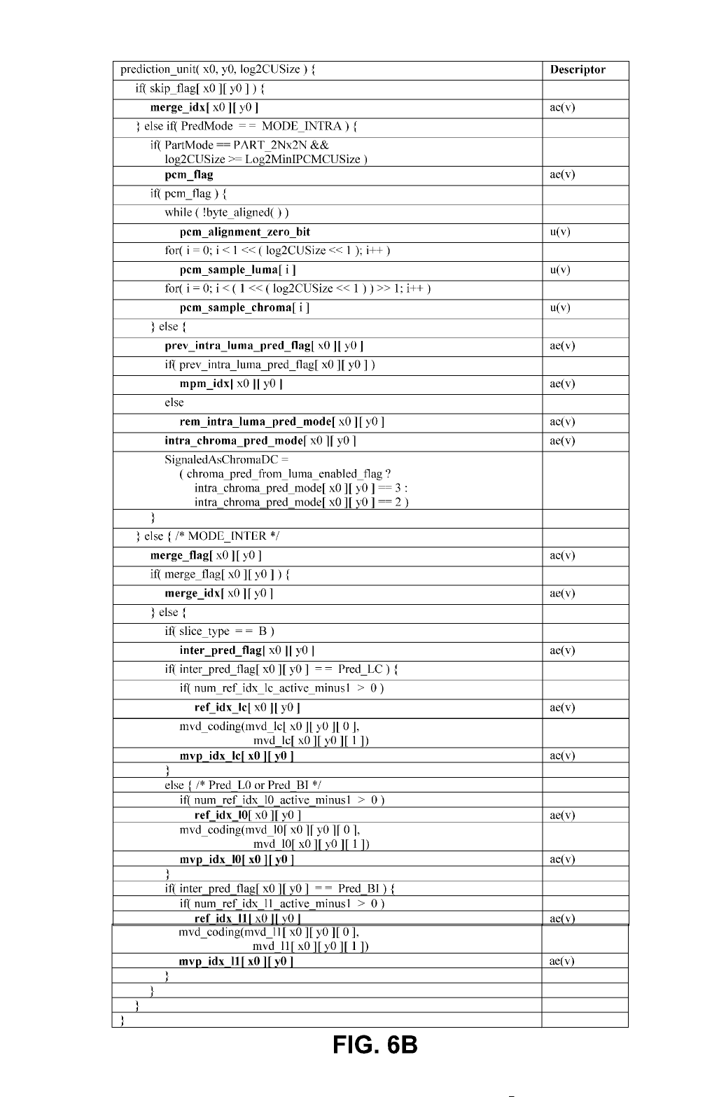

In the Merge mode, individual motion parameters are transmitted for each inter PU. In order to achieve a potentially improved coding efficiency, the block merging process is utilized to select the best motion vector predictor in a so-called Merge mode. The decoding process of the Merge mode is described below, where A, B, Col (which is an abbreviation of co-located), C, and D refer to respective candidate coding units 7A-7E shown in the example of FIG. 7.

FIG. 7 is a diagram illustrating candidate coding units 7A-7E with respect to current CU 7. Candidate CUs 7A, 7B, 7D and 7E may be referred to as spatial neighbors, while candidate CU 7C may be referred to as a co-located temporal candidate CU. If several merging candidates have the motion vectors and the same reference indices, the motion vectors selected from these candidates are removed from the list except for the motion vectors selected from a candidate that has the smallest order in the merge candidate list.

The decoding process to identify a candidate motion vector is as follows:
1) Parsing of the index of a candidate list as specific in the prediction unit: merge_idx.
2) Constructing the merge candidate list, with the following specific order:
   A (e.g., CU 7A), if availableFlagA is equal to 1
   B (e.g., CU 7B), if availableFlagB is equal to 1
   Col (e.g., the temporal co-located block CU 7C), if availableFlagCol is equal to 1
   C (e.g., CU 7D), if availableFlagC is equal to 1
   D (e.g., CU 7E), if availableFlagD is equal to 1
3) Selecting the candidate with the parsed merge_idx in the merge candidate list.

In an embodiment, the reference index and motion vector of the temporal co-located candidate might be scaled (e.g., based on the POC).

Besides the motion Merge mode, normal motion vector prediction is supported in HEVC. In normal motion vector prediction, for the current PU, a motion vector predictor (MVP) list may be constructed. The predictors may be motion vectors from spatial neighbors and/or temporal neighbors. The MVP list may contain up to three candidates, which may be referred to as a spatial left MVP A, a spatial top MVP B and a temporal MVP Col. One or more of the three candidates might not be available when, for example, the neighboring blocks are intra-coded (and therefore do not include any temporal prediction data such as motion vectors). In this case, the MVP list will have less entries and the missing candidate is considered as unavailable.

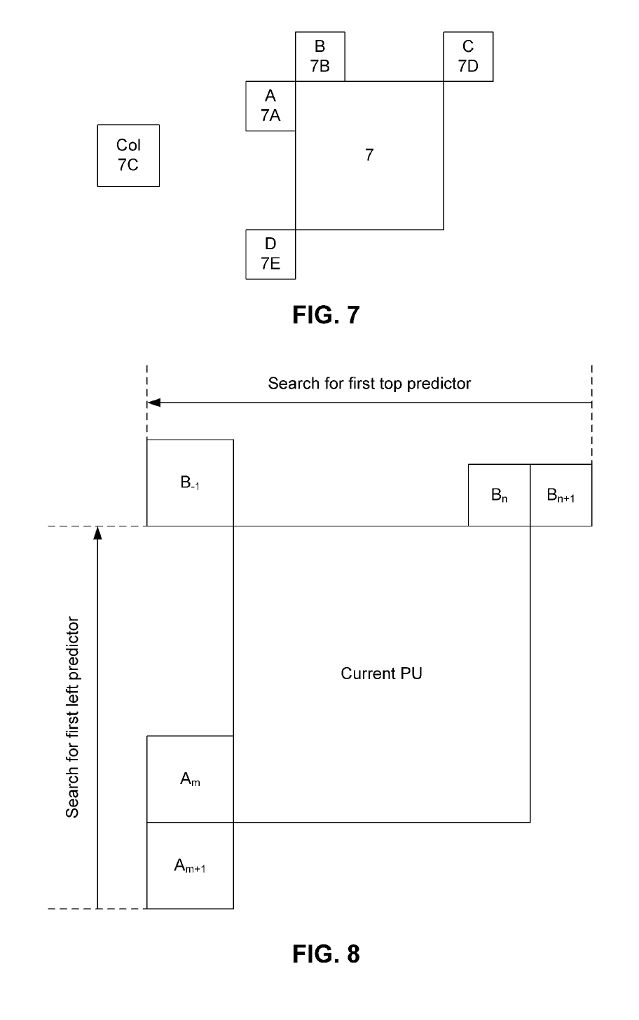

FIG. 8 is a diagram illustrating spatial candidate scanning used in performing normal motion vector prediction. As shown in the example of FIG. 8, for the search of left MVP, two neighboring PUs (e.g., Aₘ₊₁ and Aₘ in the example of FIG. 8) are used. Similarly, for the search of top MVP, up to three neighboring PUs (e.g., Bₙ₊₁, Bₙ, and B₋₁ in the example of FIG. 8) are used. Without loss of generality, only the generation of the top MVP is described for ease of illustration purposes; however the same or similar process may be performed for identifying the left MVP. A priority-based scheme is applied for deriving each spatial motion vector predictor (MVP) candidate. The priority-based scheme checks several blocks belonging to the same category (e.g., A or B). In an embodiment, the motion vectors (MVs) are checked in a certain order as follows:
1) Set the MV to the motion vector of the current checking block. If a MV in the current checking block points to the same reference picture (e.g., having the same reference index) as the current PU, the MV is selected to represent the same category, go to (4). Else go to (2).
2) If the previous block is already the last block of this category, go to (3), else, set the block to the next block of the category and go to (1).
3) Scaling the MV based on the distances: the POC distance between the current picture and the reference picture of this MV and the POC distance between the current picture and the reference picture of the current PU.
4) Exit

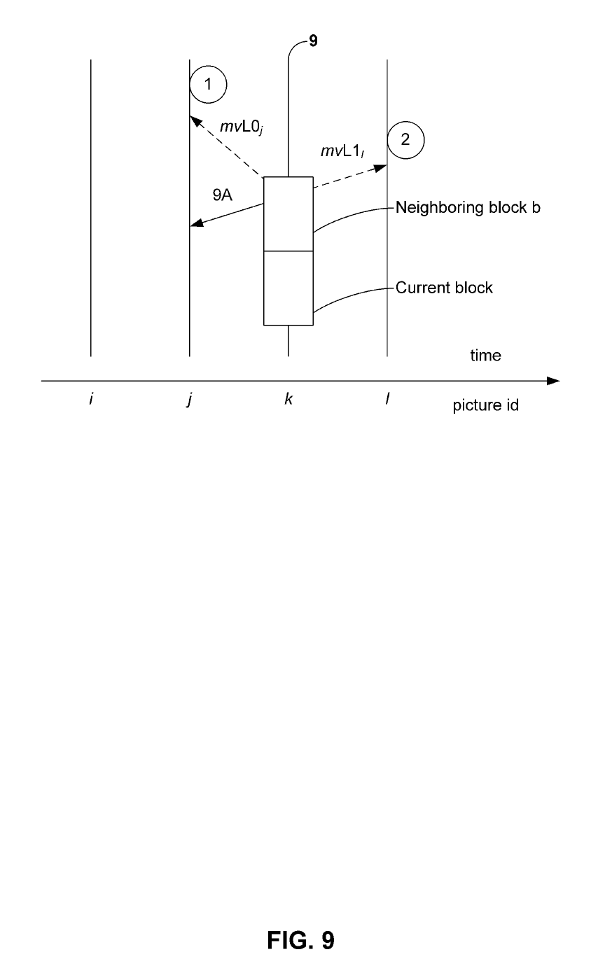

FIG. 9 is a diagram illustrating an example of deriving a spatial MVP candidate for a B-slice 6 with a single reference picture per list (picture j for list 0 and picture/for list 1). In an embodiment, assume the reference picture for the final MVP is picture/based on the already signaled ref idx for the current PU. The current list is list 0, and the reference picture of the current PU is picture j. The dotted arrow mvL0ⱼ denotes the list 0 MV of the neighboring block, and the dotted arrow mvL1ₗ denotes the list 1 MV of the neighboring block. The numbers 1 and 2 (in circles) denote the priorities of the two MVs. When the list 0 MV is available, it is used as the spatial MVP candidate. Otherwise, when the list 1 MV is available, it is scaled to the current reference picture (e.g., shown in FIG. 9 as solid arrow 9A) based on the POC distances and then used as the spatial MVP candidate.

In an embodiment, one temporal motion vector predictor (e.g., mvL0Col or mvL1Col) is selected according to the current list and the current reference picture, and added to the MVP list. mvL0Col (e.g., shown as mvL0ⱼ in the example of FIG. 9) or mvL1Col (e.g., shown as mvL1ₗ in the example of FIG. 9) are derived based on the motion vectors of the temporal co-located block and the POC difference between the current picture and the current reference picture and the POC difference between the co-located picture and the reference picture referenced by the co-located temporal block. When there are multiple candidates in the MVP list, an index is signaled to indicate which candidate is to be used.

FIG. 10 is a block diagram illustrating an example of a video encoder that may implement techniques in accordance with aspects described in this disclosure. Video encoder 20 may be configured to perform any or all of the techniques of this disclosure. As one example, mode select unit 40 may be configured to perform any or all of the techniques described in this disclosure. However, aspects of this disclosure are not so limited. In some examples, the techniques described in this disclosure may be shared among the various components of video encoder 20. In some examples, in addition to or instead of, a processor (not shown) may be configured to perform any or all of the techniques described in this disclosure.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 10, video encoder 20 receives a current video block within a video frame to be encoded. In the example of FIG. 10, video encoder 20 includes mode select unit 40, reference frame memory 64, summer 50, transform processing unit 52, quantization unit 54, and entropy encoding unit 56. Mode select unit 40, in turn, includes motion estimation unit 42, motion compensation unit 44, intra-prediction unit 46, and partition unit 48. For video block reconstruction, video encoder 20 also includes inverse quantization unit 58, inverse transform unit 60, and summer 62. A deblocking filter (not shown in FIG. 10) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes (e.g., to select an appropriate coding mode for each block of video data).

Moreover, partition unit 48 may partition blocks of video data into sub-blocks, based on an evaluation of previous partitioning schemes in previous coding passes. For example, partition unit 48 may initially partition a frame or slice into LCUs, and partition each of the LCUs into sub-CUs based on a rate-distortion analysis (e.g., rate-distortion optimization). Mode select unit 40 (e.g., partition unit 48) may further produce a quadtree data structure indicative of partitioning of an LCU into sub-CUs. As described above, leaf-CUs of the quadtree may include one or more PUs and one or more TUs.

Mode select unit 40 may select one of the coding modes (e.g., intra or inter) based on error results, and provide the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 can be highly integrated, but are illustrated separately for conceptual purposes. Motion estimation or the prediction of motion information, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (e.g., List 0), a second reference picture list (e.g., List 1), or a third reference picture list (e.g., List C), each of which identify one or more reference pictures stored in reference frame memory 64. As described above, the reference picture may be selected based on the motion information of blocks that spatially and/or temporally neighbor the PU. The selected reference picture may be identified by a reference index. Motion estimation unit 42 sends the calculated motion vector and/or the reference index to entropy encoding unit 56 and/or motion compensation unit 44.

Motion compensation, performed by motion compensation unit 44, may involve fetching or generating the predictive block based on the motion vector determined by motion estimation unit 42. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In some embodiments, motion estimation unit 42 can perform motion estimation relative to luma components, and motion compensation unit 44 can use motion vectors calculated based on the luma components for both chroma components and luma components. Mode select unit 40 may generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, in some embodiments. In particular, intra-prediction unit 46 may determine an intra-prediction mode to use to encode a current block. In some examples, intra-prediction unit 46 may encode a current block using various intra-prediction modes (e.g., during separate encoding passes) and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

As described above, video encoder 20 forms a residual video block by subtracting the prediction data provided by mode select unit 40 from the original video block being coded. Summer 50 represents the component or components that perform this subtraction operation. Transform processing unit 52 applies a transform, such as a DCT or a conceptually similar transform (e.g., wavelet transforms, integer transforms, sub-band transforms, etc.), to the residual block, producing a video block comprising residual transform coefficient values. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform CAVLC, CABAC, SBAC, PIPE coding, or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain (e.g., for later use as a reference block). Motion compensation unit 44 may calculate a reference block by adding the residual block to a predictive block of one of the frames stored in reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

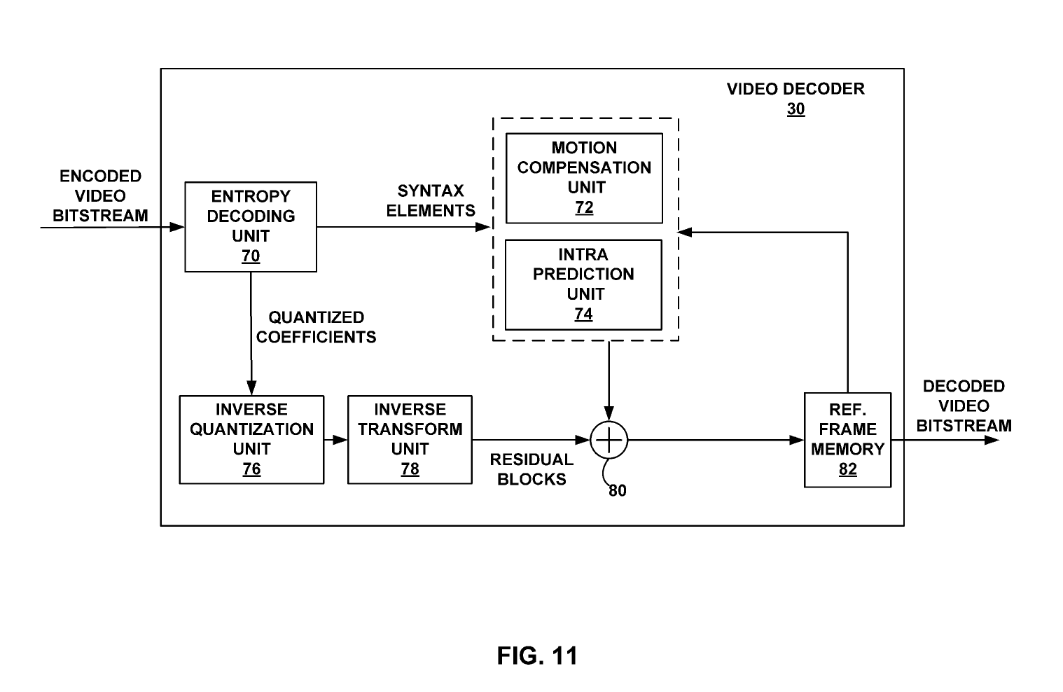

FIG. 11 is a block diagram illustrating an example of a video decoder that may implement techniques in accordance with aspects described in this disclosure. Video decoder 30 may be configured to perform any or all of the techniques of this disclosure. As one example, motion compensation unit 72 and/or intra prediction unit 74 may be configured to perform any or all of the techniques described in this disclosure. However, aspects of this disclosure are not so limited. In some examples, the techniques described in this disclosure may be shared among the various components of video decoder 30. In some examples, in addition to or instead of, a processor (not shown) may be configured to perform any or all of the techniques described in this disclosure.

In the example of FIG. 11, video decoder 30 includes an entropy decoding unit 70, motion compensation unit 72, intra prediction unit 74, inverse quantization unit 76, inverse transformation unit 78, reference frame memory 82, and summer 80. Video decoder 30 may, in some examples, perform a decoding pass generally reciprocal to the encoding pass described with respect to video encoder 20 (FIG. 10). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and/or other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (e.g., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0, List 1, and/or List C, using default construction techniques based on reference pictures stored in reference frame memory 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and/or other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes (e.g., de-quantizes) the quantized transform coefficients provided in the bitstream and decoded by entropy decoding unit 70. The inverse quantization process may include use of a quantization parameter QP_{Y} calculated by video encoder 20 for each video block in the video slice to determine a degree of quantization and, likewise, a degree of inverse quantization that should be applied.

Inverse transform unit 78 applies an inverse transform (e.g., an inverse DCT), an inverse integer transform, or a conceptually similar inverse transform process, to the transform coefficients in order to produce residual blocks in the pixel domain.

In some cases, inverse transform unit 78 may apply a 2-dimensional (2-D) inverse transform (in both the horizontal and vertical direction) to the coefficients. According to the techniques of this disclosure, inverse transform unit 78 may instead apply a horizontal 1-D inverse transform, a vertical 1-D inverse transform, or no transform to the residual data in each of the TUs. The type of transform applied to the residual data at video encoder 20 may be signaled to video decoder 30 to apply an appropriate type of inverse transform to the transform coefficients.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference frame memory 82 also stores decoded video for later presentation on a display device, such as display device 32 of FIG. 5.

A number of problems may arise with SVC as implemented in H.264/AVC and/or HEVC. First, in the H.264/SVC, an IntraBL mode may be considered as intra-coding mode. As a result, the motion vector of a MB using this mode may not be available. This, if extended to HEVC based SVC, which may be implemented using multiple-loop decoding, may result in less accurate motion vector candidates. Second, using a temporal motion vector may result in less error resilience, where, in some application scenarios, this temporal motion candidate is disabled. Third, coding of the split flag for coding trees may result in a significant increase in the amount of bits.

The techniques and proposed modes described herein may reduce or minimize problems these problems, providing techniques and/or modes for performing texture, CU hierarchy, and motion vector predictions for the ELs of a SVC bitstream. Joint texture and motion prediction techniques are described such that, even when a CU is predicted from the reconstructed lower layer pixels (and thus considered as intra-coded), the motion vector of the predicting CU, if available, may be used to predict the current intra-coded CU. In addition, the techniques may provide for a motion vector prediction mode from coding tree or CU to a CU. Moreover, the techniques may provide motion vector prediction at the PU: in AMVP mode or Merge mode, the inter-layer predicted motion provided by the various aspects of the techniques described in this disclosure may be used and the temporal motion vector candidate may not be used when the inter-layer predicted motion vector candidate is available.

The following modes are described in detail below. For each of the proposed modes, a flag in the slice level (e.g., slice header) or picture level (e.g., picture parameter set) or sequence level (e.g., sequence parameter set) can be signaled to turn a mode on or off.

### INTRA_BL Mode

Generally, in INTRA_BL mode (e.g., IntraBL mode or TEXTURE_BL mode), as described above, a reconstructed texture of the BL can be used as a predictor for the EL. For example, the reconstructed texture of a co-located BL block can be used as a predictor for a current EL block. However, motion information from the co-located BL block may not be used for coding the current EL block because INTRA_BL mode only applies when the co-located BL block is coded using the constrained intra prediction mode (e.g., the co-located BL block is intra-coded without referring to any samples from neighboring blocks that are inter-coded). Thus, the current EL block does not include any motion information in INTRA_BL mode.

As described above, motion estimation or the prediction of motion information for a PU (e.g., performed by the motion estimation unit 42 of the video encoder 20) relies on neighboring blocks including motion information. For example, the one or more motion vectors used to code a block are derived from a candidate list of motion vector predictors provided by spatial and/or temporal neighbors of the block. If the current EL block does not include any motion information, the coding of neighboring EL blocks may be less accurate since the candidate list will include fewer motion vector predictors that can be used to derive the one or more motion vectors. However, by calculating the motion vectors even when in INTRA_BL mode, the candidate list may include a larger selection of motion vector predictors. Accordingly, a joint texture and motion prediction mode may be proposed such that even though motion information from a co-located BL block may not be used for coding the current EL block, the motion information may be inherited anyway and used to populate the motion information of the current EL block. The motion information at the current EL block can then be used for prediction of motion information of a subsequent or neighboring EL block.

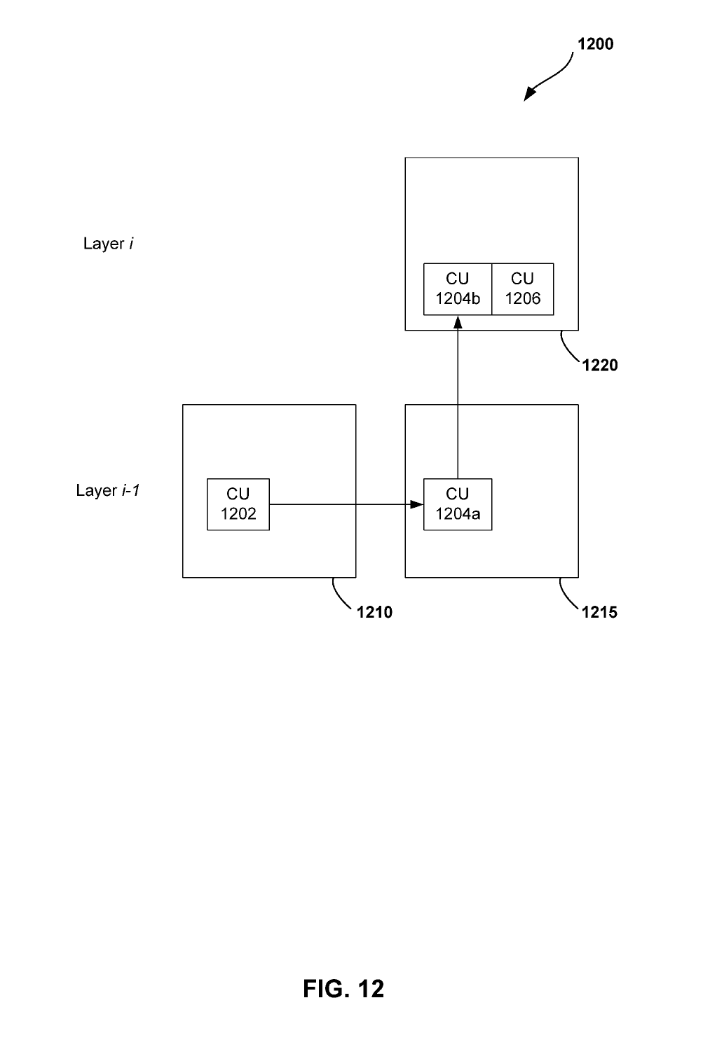

FIG. 12 illustrates a block diagram 1200 of a higher level layer and a lower level layer operating in a joint texture and motion prediction mode. As illustrated in FIG. 12, a lower level layer is represented by Layer i-1 and a higher level layer is represented by Layer i. Layer i-1 includes slice 1210 and slice 1215. Layer i includes slice 1220. Slice 1210 includes CU 1202, slice 1215 includes CU 1204a, and slice 1220 includes CU 1204b and CU 1206. While FIG. 12 illustrates CUs, the disclosure as provided herein may apply to any type of block.

In an embodiment, CU 1202 is a temporally co-located neighbor of CU 1204a. Likewise, CU 1204a is co-located with CU 1204b and CU 1206 may be a spatial neighbor of CU 1204b.

In an embodiment, one or more motion vectors may be available at CU 1204a. For example, one or more motion vectors may be available at CU 1204a because slice 1215 and/or CU 1204a may be inter-coded. In another example, one or more motion vectors may be available at CU 1204a because the spatial and/or temporal neighbors of CU 1204a may be inter-coded. The one or more motion vectors may be calculated for CU 1204a based on motion information (e.g., motion vector predictors) provided by the spatial and/or temporal neighbors of CU 1204a. As an example, as illustrated in FIG. 12, the one or more motion vectors are calculated for CU 1204a based on motion information provided by CU 1202.

In a further embodiment, some or all of the motion vectors calculated for CU 1204a may be inherited by CU 1204b. Some or all of the motion vectors may be inherited via the introduction of new syntax elements.

The slice 1215 may be associated with a flag that indicates whether the slice 1215 belongs to an EL. For example, the flag may be named “EnhanceFlag” and included in the encoded video bitstream generated by the entropy encoding unit 56. If the EnhanceFlag flag is high, the flag indicates that the slice 1215 belongs to an EL. As illustrated in FIG. 12, slice 1215 belongs to an EL, layer i, and thus the flag is high.

Another flag may be used to indicate how the texture of an EL block (e.g., CU 1204b) is predicted. For example, the flag that indicates how the texture of the EL block is predicted may be named “base_pred_flag.” If the base_pred_flag is high, the flag may indicate that the texture of the EL block is predicted directly from the reconstructed texture of a co-located BL. For example, the base_pred_flag is high if the texture of CU 1204b is predicted directly from the reconstructed texture of CU 1204a. If the base_pred flag is low, the flag may indicate that the texture of the EL block is not predicted from the reconstructed texture of the co-located BL block.

In an embodiment, if the base_pred_flag is high when motion vectors are available at the co-located BL block (e.g., when available at CU 1204a), the motion vectors are used to calculate motion vectors in the EL. In some embodiments, the motion vectors available at the BL block may be scaled before calculating the motion vectors in the EL. Thus, motion vectors may be calculated in the EL even if a current EL block is coded according to the INTRA BL mode as long as the motion vectors are available at the co-located BL block. In other words, motion vectors may be calculated in layer i even if CU 1204b is coded according to the INTRA_BL mode as long as the motion vectors are available at CU 1204a. In those cases in which the current EL block (e.g., CU 1204b) is intra-coded, the calculated motion vectors may be used for the coding of spatial and/or temporal neighbors of the current EL block (e.g., CU 1206).

Accordingly, if the base_pred_flag is high when motion vectors are available at CU 1204a, CU 1204b may inherit some or all of the motion vectors available at CU 1204a. These inherited motion vectors may then be used when coding CU 1206 or another neighbor of CU 1204b.

In a further embodiment, the above-described process may be extended to an entire slice (e.g., slice 1210, slice 1215, slice 1220, etc.). For example, a header of slice 1215 may indicate (e.g., via a flag) that each co-located BL block (e.g., CU 1204a) in slice 1215 is configured to calculate motion vectors regardless of whether the EL block (e.g., CU 1204b) is intra-coded. The header of the slice 1215 may also indicate that the BL blocks are not split unless the BL block is in a slice boundary. Accordingly, no split flag or base_pred_flag may be signaled in the encoded video bitstream.

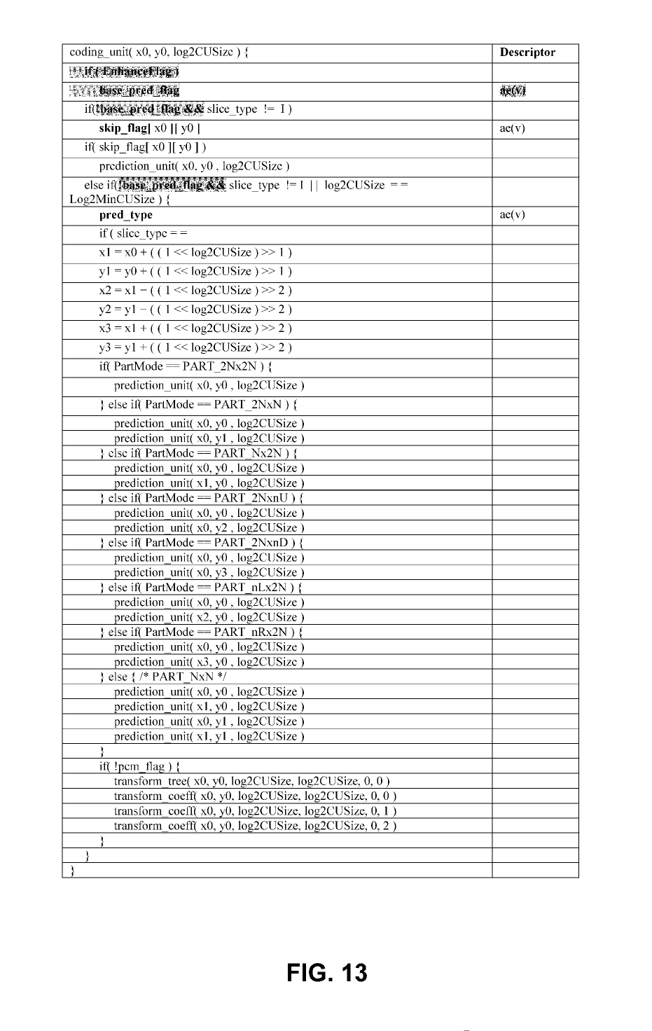

FIG. 13 illustrates exemplary syntax defined for a coding unit in the INTRA_BL mode. A slice level flag is derived (e.g., based on the NAL unit header of a slice) to indicate if the slice belongs to an (spatial) EL or not. As illustrated in FIG. 13 and as described above, such a flag is named EnhanceFlag. In an embodiment, when the base_pred_flag syntax element is equal to 1, the base_pred_flag syntax element indicates that the texture of the current CU in the EL is predicted directly from the reconstructed texture of the co-located CUs in the BL for the EL. When the base_pred_flag is equal to 0, the base_pred_flag syntax element indicates that the texture of the current CU is not predicted from the reconstructed texture of the co-located CUs in the BL for the current EL.

In an embodiment, as described above, if base_pred_flag is 1 for a CU, motion vectors are used after possible scaling to construct the motion vectors of the current CU of the current layer when motion vectors are available at the co-located BL CUs. So even if the current CU is not inter coded, the current CU's motion parameter information may be available and can be used for the coding of spatial/temporal neighboring CUs, as if the current CU was inter coded, although it is coded as an Intra BL mode (with base_pred_flag equal to 1).

In other words, when performing Merge mode or AMVP mode in the EL, when a spatial neighboring CU of a current CU located in the EL is predicted according to an IntraBL mode, the spatial neighboring block's co-located CU in the BL may have been temporally predicted. Thus, the spatial neighboring CU's co-located CU may have motion information (e.g., one or more motion vectors and associated reference pictures indexes, etc.) that can be used as a candidate motion vector for the current CU in the EL. In this respect, even though the spatial neighboring CU is coded using the IntraBL mode, which would normally be construed as not having any motion information, the co-located CU for the spatial neighboring CU in the BL may have motion information, which according to the techniques of this disclosure, may be used as a motion vector candidate for a current CU in the enhancement layer.

In this manner, a video coding device for scalable coding of video data having a base layer and an enhancement layer may implement the techniques of this disclosure. The video coding device may comprise one or more processors that determine whether a neighboring coding unit of a current coding unit in the enhancement layer is intra-coded, in response to the determination that the neighboring coding unit is intra-coded, determine whether a coding unit in the base layer that is co-located with respect to the neighboring coding unit includes motion information and, in response to the determination that the coding unit in the base layer that is co-located with respect to the neighboring coding unit includes motion information, identify the motion information of the coding unit in the base layer as candidate motion vector information for the current coding unit in the enhancement layer.

The one or more processors may further refine the candidate motion vector information to generate refined candidate motion vector information for the current coding unit in the enhancement layer. Additionally, the one or more processors may scale the candidate motion vector information to generate the refined candidate motion vector information for the current coding unit in the enhancement layer. Moreover, the one or more processors may determine whether the neighboring coding unit was intra-coded according to an IntraBL mode. In some instances, the one or more processor may determine a base_pred_flag syntax element that indicates whether the neighboring coding unit of the current coding unit is intra-coded according to an IntraBL mode and determine whether the neighboring coding unit was intra-coded according to an IntraBL mode based on the determined base_pred_flag.

In an embodiment, such a mode may be extended to the whole slice, where a flag in the slice header indicates each CU selects such mode and all CUs are not split (unless if a CU is in a slice boundary) thus no split flag or base_pred_flag is signaled. FIG. 13 provides the syntax for the CU, where the highlighted and bolded aspects indicate syntax elements that are added to currently adopted or proposed HEVC syntax elements, consistent with the techniques described in this disclosure.

### Inter-Coding Tree to CU Prediction

As described above, a slice in a layer includes a number of LCUs (e.g., coding trees, quadtrees, etc.), which may be further split into CUs and/or sub-CUs. For the inter-coding tree to CU prediction aspects of the techniques described herein, a current CU in the EL may correspond to a CU tree (e.g., LCU) of the BL, to enable motion prediction from a CU tree or CU of a BL to a current CU of the EL. The techniques may provide a new pred_type syntax element to indicate such a mode.

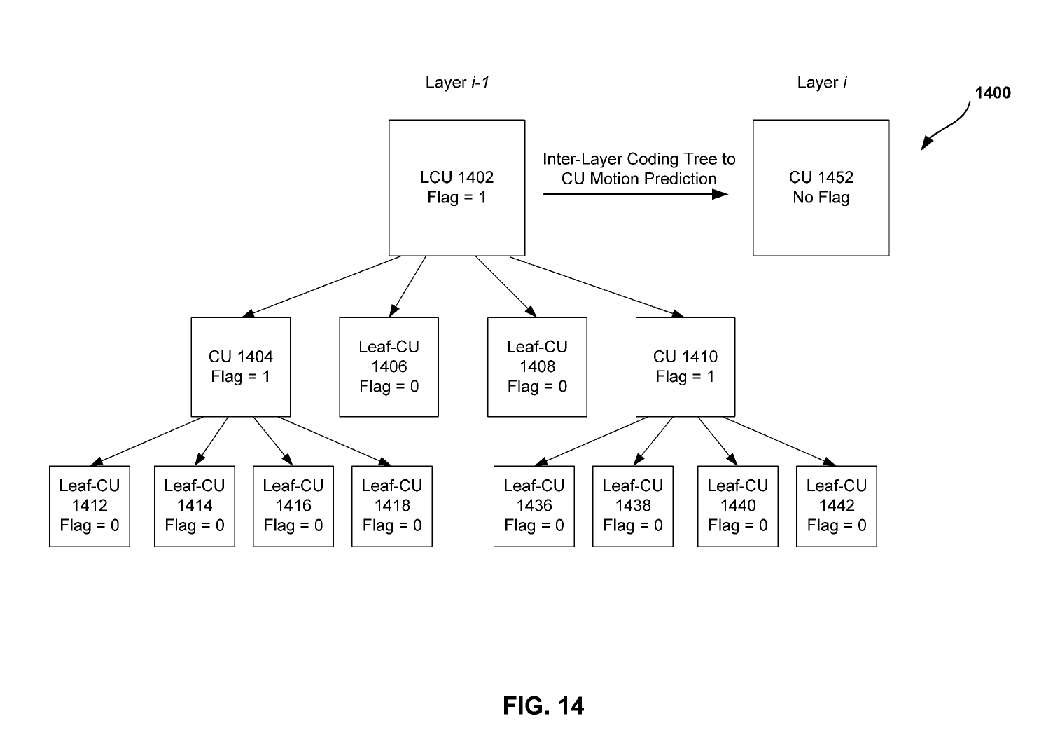

FIG. 14 illustrates an exemplary structure 1400 of an LCU 1402 in a slice. As illustrated in FIG. 14, LCU 1402 is split into four CUs 1404, 1406, 1408, and 1410. CU 1404 is further split into four sub-CUs 1412, 1414, 1416, and 1418. Likewise, CU 1410 is further split into four sub-CUs 1436, 1438, 1440, and 1442. In an embodiment, CUs 1406 and 1408 and sub-CUs 1412, 1414, 1416, 1418, 1436, 1438, 1440, and 1442 are considered leaf-CUs because they are not further split. LCU 1402 and its corresponding CUs and sub-CUs may be located in a slice in a layer i-1 (e.g., a lower level layer, a BL, etc.). Motion vectors at LCU 1402 may be available for motion prediction.

FIG. 14 further illustrates another CU, CU 1452, which may be located in a slice in a layer i (e.g., a higher level layer, an EL, etc.). In an embodiment, LCU 1402 may be co-located with CU 1452. For example, CU 1452 may be located at a position in layer i that corresponds with a position of co-located LCU 1402 in layer i-1.

When CU 1452 is inter-mode coded, motion vectors available at LCU 1402 may be used to perform motion prediction or estimation in CU 1452. For example, CU 1452 may be split into the same hierarchy or structure 1400 as co-located LCU 1402 (e.g., CU 1452 may itself be an LCU that has the same tree structure 1400 as co-located LCU 1402). A motion vector for CU 1404, 1406, 1408, 1410, 1412, 1414, 1416, 1418, 1436, 1438, 1440, and/or 1442 may then be used to perform motion prediction for a corresponding CU in CU 1452.

Generally, a split flag indicates how LCU 1402 is split. For example, as illustrated in FIG. 14, if a split flag is “1” or high, the split flag may indicate that a LCU or CU is split into four child nodes (e.g., four CUs or four sub-CUs). Thus, a node with a split flag value of 1 in the quadtree represents a coding tree. If the split flag is “0” or low, the split flag may indicate that the LCU or CU is not split into any child nodes, and is thus a leaf-CU. Thus, a node with a split flag value of 0 (which is a leaf) in the quadtree represents a CU. Each of the four child nodes may also be associated with a split flag, where the split flag indicates whether the respective child node is further split.

The split flags may be signaled in the encoded video bitstream as syntax elements such that the video decoder 30 (e.g., motion compensation unit 72) can determine how LCUs and/or CUs in slices in one or more layers are to be split. However, the split flags may require a significant number of bits. Thus, signaling the split flags for an LCU or CU in a slice in the lower level layer and for an LCU or CU in a slice in the higher level layer may be costly. Accordingly, a new partition mode may be introduced that removes the requirement that the split flags be signaled for LCUs or CUs in a slice in the higher level layer.

In an embodiment, the new partition mode, named partition base (e.g., PART_BASE), is available as an option when a CU is inter-mode coded. To illustrate, in one case of inter-layer motion prediction, the EL CU can be predicted from a co-located coding tree. For example, if CU 1452 has a partition mode of PART_BASE, CU 1452 is treated as an LCU when creating motion information. CU 1452 may then be split according to the tree structure 1400 of its co-located LCU 1402 in the lower level layer (e.g., layer i-1). No split flag is signaled in the encoded video bitstream for CU 1452 since it is split according to its co-located lower level layer LCU 1402. In some embodiments, use of the PART BASE partition mode is used in CGS, spatial scalability (e.g., with dyadic spatial resolution, with any ratio between 1 and 2, etc.), and the like.

In an embodiment, in other words, the EL CU may infer the split flags from the co-located CU tree in the BL such that the split flags need not be re-signaled for the EL CU. The split flags are then applied to the EL CU for the purposes of prediction. As described below, the transform coefficients, however, may not be inferred from the BL CU tree and may be specified separately for the EL CU.

In an embodiment, in order to maintain the CU syntax as defined in HEVC, transform coefficients are signaled in the encoded video bitstream for the entire CU 1452. For example, the transform coefficients may be signaled for a block in CU 1452 that has a size that is the minimum of either the maximum transform size (e.g., maximum TU size) or the CU 1452 size.

In a further embodiment, the use of the PART_BASE partition mode may be extended to an entire slice of layer i. For example, a header of the slice in layer i may indicate (e.g., via a flag) that each CU in the slice (e.g., CU 1452) is configured in the PART_BASE partition mode and the CUs may not be split except for those CUs in a slice boundary. In such a case, the split flag of each CU in the slice in layer i is inferred to be low (e.g., zero) and the CUs only include syntax elements related to the transform coefficients (e.g., only syntax elements related to the transform coefficients are included in the encoded video bitstream because they may not be inferred from LCU 1402). As another example, a flag in the slice header indicates each CU selects such IntraBL mode and all CUs are not split (except the CU that is in a slice boundary). Thus no split flag or base_pred_flag is signaled. In that case, the split flag of each LCU is inferred to be equal to 0 and base_pred_flag of each CU is inferred to be equal to 1.

If a CU in layer i-1, such as CU 1404, 1406, 1408, 1410, and so on, is intra-coded, the corresponding CU in layer i (e.g., the corresponding sub-CU in CU 1452) is coded in the INTRA BL mode. As described above, this may be extended to an entire slice such that a header of a BL slice indicates (e.g., via a flag) that each BL block in the BL slice is configured to calculate motion vectors regardless of whether the EL block is intra-coded. The header of the slice may also indicate that the BL blocks are not split unless the BL block is in a slice boundary. Accordingly, no split flag or base_pred_flag may be signaled in the encoded video bitstream, and the split flag of each LCU in the BL slice may be inferred to be low (e.g., zero) and the base_pred_flag of each CU in the BL slice may be inferred to be high (e.g., one).

In a further embodiment, if the co-located region of CU 1452 is a leaf-CU (e.g., the co-located region of CU 1452 is not split), then CU to CU motion prediction applies with the same syntax elements and the same partition mode as described above for the co-located LCU 1402 to CU 1452 motion prediction.

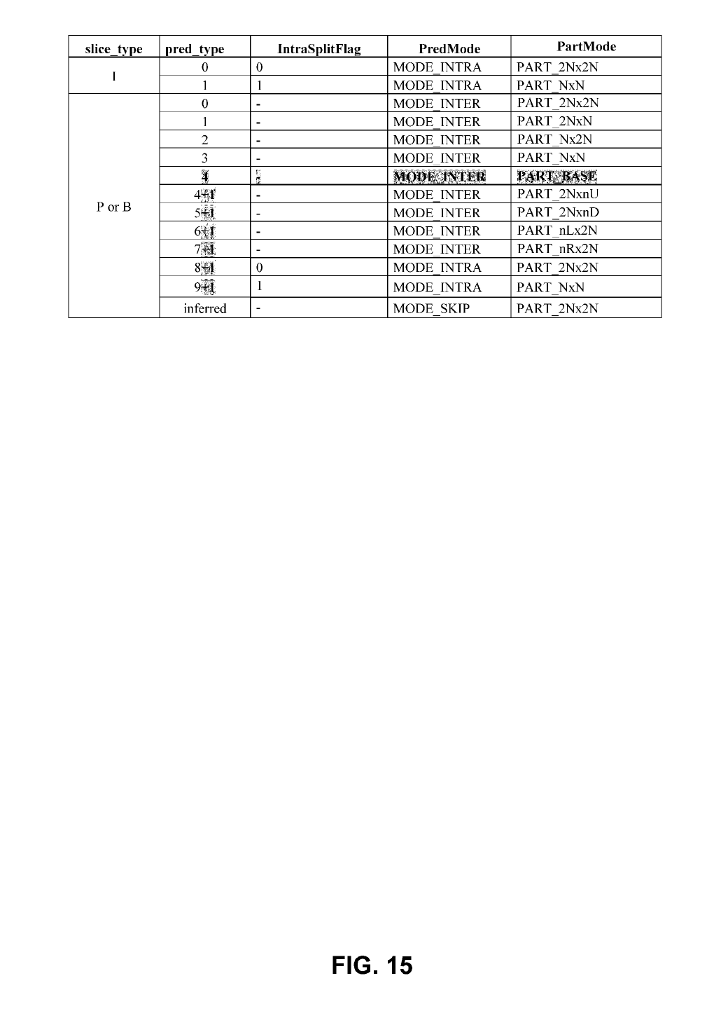

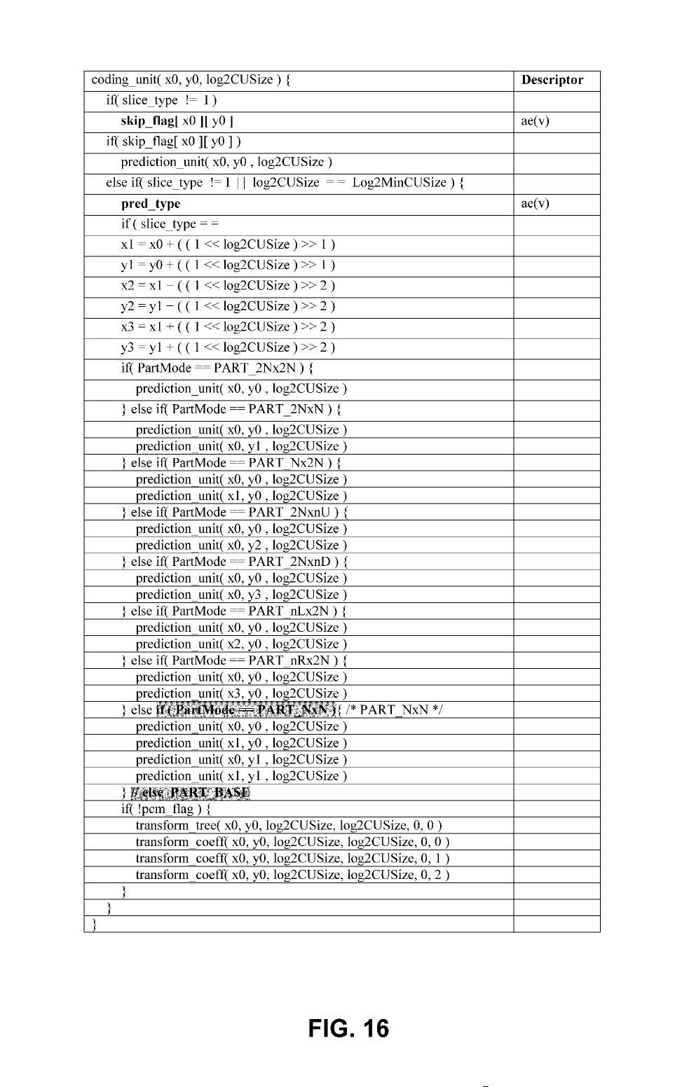

As noted above, a new partition mode can be added for Inter CU in an EL. FIG. 15 provides name associations to prediction mode and partitioning type, where the new mode is highlighted and bolded. FIG. 16 illustrates the CU syntax elements for the new mode discussed above.

In an embodiment, as discussed above, the decoding process for this new mode may entail the following steps. When the current inter CU in the EL has a partition mode of PART_BASE, the co-located BL region is a CU tree (e.g., an LCU) or current CU (although if its associated split flag, as signaled in the bitstream, indicates it is a CU, it is treated as a coding tree during the decoding process when creating the motion information).

For example, in the case of CGS (two spatial layers with the same resolution), a CU has a co-located CU tree (at the BL) which is split into four nodes, some of which may be further split into another four nodes. If the current partition mode of this CU is PART_BASE, the video decoder (e.g., the motion compensation unit 72 of a video decoder 30) determines that the current CU is further split into four CUs, although there is no split flag signaled for at this CU level. In this manner, the cost of sending the split flag may be avoided.

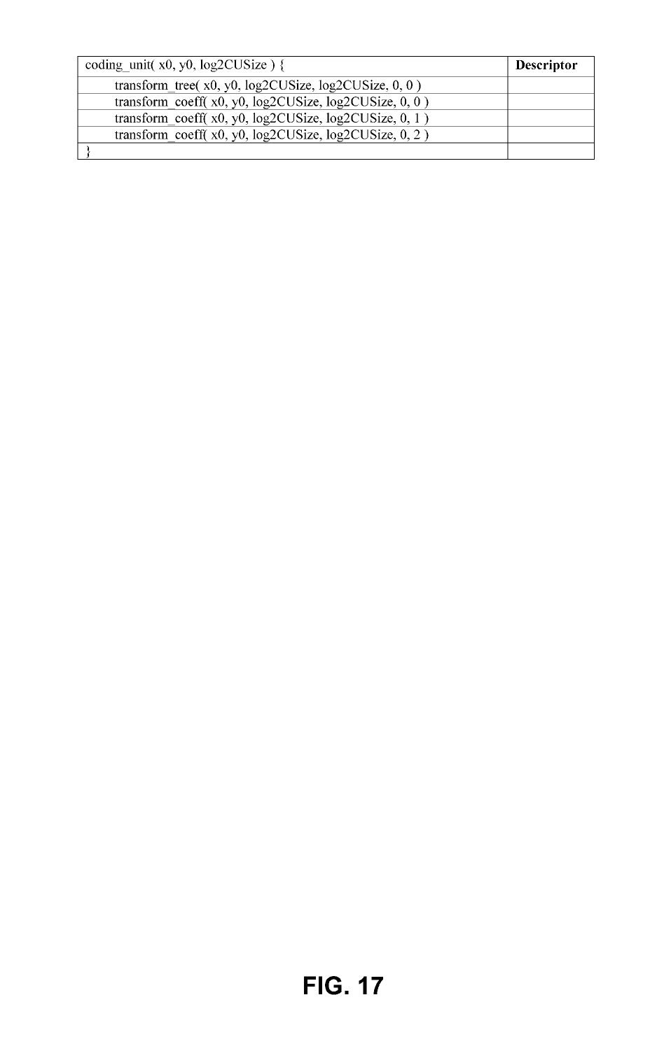

FIG. 17 illustrates a current syntax design. In an embodiment, as described above, to code the transform coefficients in the transform tree and transform coefficient syntax tables, various aspects of the techniques may be implemented such that the split_tranform_flag is only signaled at the level of the block size, which is the minimum of the maximum transform size and the current CU size (which may be expressed mathematically as min(max_transform_size, current_CU_size)). Thus, the current syntax design as illustrated in FIG. 17 may be used.

In an embodiment, as described above, a CU (if it is inter-layer predicted from a coding tree) may be further split into CUs with the same or similar hierarchy as the BL coding tree and motion compensated based on the motion vectors from the BL coding tree during the decoding process. However, the coefficients may be signaled for the whole CU in the syntax tables of the transform tree syntax element and the transform coeff syntax element, similar to the current HEVC design. In one alternative embodiment, the motion vectors predicted from a coding tree may be further refined. Although the example is described above with respect to CGS, such a mode is applicable to spatial scalability (with dyadic spatial resolution or even any ratio between 1 and 2, to name a few examples).

Again, as described above, such a mode may be extended to the whole slice, where a flag in the slice header indicates each CU selects such mode and all CUs are not split (except the CU that is in a slice boundary). In that case, the split flag of each LCU may be inferred to be equal to 0 and the coding unit in such a mode only contains syntax elements as follows for each CU of the slice. If a CU at the base layer happens to be Intra coded, the corresponding CU is coded as in the IntraBL mode.

In an embodiment, as described above, for CU to CU prediction, if the co-located region of the current CU is just one CU, CU to CU prediction may apply with the same syntax elements and partition mode as those for the CU tree to CU prediction. For PU to PU prediction, motion vectors from the co-located PUs may be used to predict a current PU, as described below.

In this manner, a video coding device may implement the techniques described in this disclosure to provide for scalable coding of video data having a base layer and an enhancement layer. The video coding device may include one or more processors that determine a co-located coding unit tree in the base layer for a current coding unit in the enhancement layer, wherein the coding unit tree in the base layer is split into two or more coding units and includes one or more split flags indicating how the coding unit tree is split into the two or more coding units, split the current coding unit in the enhancement layer in accordance with the one or more split flags included in the co-located coding unit tree to generate two or more coding units in the enhancement layer and perform motion prediction with respect to each of the two or more coding units in the enhancement layer generated from splitting the current coding unit.

In some instances, the current coding unit in the enhancement layer includes a split flag indicating that the current coding unit is not split into smaller coding units. The current coding unit may also include transform coefficients and may not infer any transform coefficients from the co-located coding unit tree.

Additionally, the one or more processors may further perform inter-layer motion prediction with respect to each of the two or more coding units in the enhancement layer generated from splitting the current coding unit such that the two or more coding units in the enhancement layer are coded with respect to the two or more coding units in the base layer. In some instances, the one or more processors, when performing motion prediction with respect to each of the two or more coding units in the enhancement layer generated from splitting the current coding unit, set a coding mode to a partial base (PART_BASE) coding mode.

### PU to PU Prediction

As described above, if a current PU in an EL inter-coded in the Merge mode or AMVP mode, a list of motion vector predictors may be used for motion prediction. Generally, the list of motion vector predictors may be provided by PUs in the EL that are spatial and/or temporal neighbors of the current PU. However, in some applications, including in the list a motion vector predictor from a temporal neighbor of the current PU may be less error resilient.

Accordingly, in some embodiments, the list is modified to include a motion vector predictor that originated from a co-located BL PU (e.g., a block that is located at a position in the BL that corresponds with a position of the current block in the EL). The list may be modified such that the motion vector predictor that originated from the co-located BL PU supplements the existing list or replaces the motion vector predictor of the temporal neighbor of the current PU. The motion vector derived from the co-located BL PU may be scaled based on a spatial resolution ratio.

In an embodiment, as described above, a motion vector of the BL PU, after potential scaling based on the spatial resolution ratio, may be added into the AMVP or Merge list. In one alternative embodiment, this motion vector, if available, may be added as the first candidate of the AMVP or Merge list. In another alternative embodiment, this motion vector, if available, may be added as a candidate of the AMVP or Merge list and the temporal motion vector is not added. In another alternative embodiment, if the current layer has a BL, a temporal motion vector may never be added into the AMVP or Merge list.

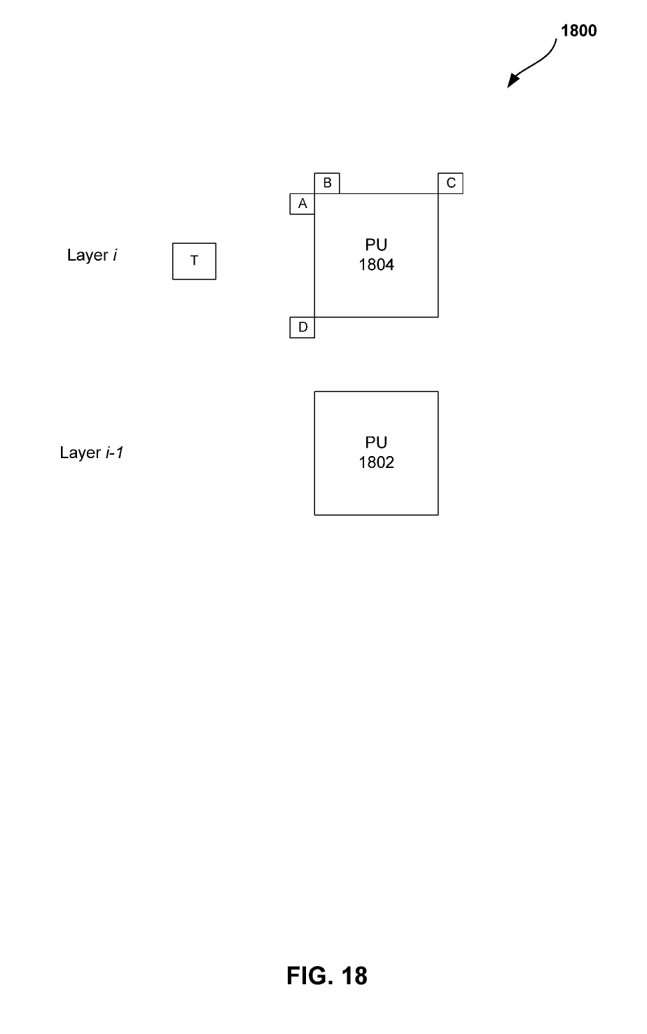

FIG. 18 illustrates a block diagram 1800 of a higher level layer and a lower level layer. As illustrated in FIG. 18, a lower level layer, layer i-1, and a higher level layer, layer i, are present. Layer i-1 includes a PU 1802. Layer i includes a PU 1804. Blocks A, B, C, and D represent spatial neighbors of PU 1804. Block T represents a temporal neighbor of PU 1804. In an embodiment, PU 1802 may be co-located with PU 1804, such that PU 1802 is located at a position in layer i-1 that corresponds with a position of PU 1804 in layer i.

In some embodiments, the motion vector predictor (e.g., a motion vector or other motion information) of co-located PU 1802, if available, is added as the first candidate in the AMVP or Merge candidate list of motion vector predictors. In other embodiments, the motion vector predictor of co-located PU 1802, if available, is added as a candidate in the AMVP or Merge candidate list and a motion vector predictor that originated from block T (e.g., a temporal neighbor of PU 1804) is not added to the AMVP or Merge candidate list. In still other embodiments, if the higher level layer (e.g., layer i) corresponds with a lower level layer (e.g., layer i-1), a motion vector predictor that originated from a temporal neighbor of PU 1804 (e.g., a motion vector predictor that originated from block T) is never be added to the AMVP or Merge candidate list.

A video coding device may implement the above described aspects of the techniques set forth in this disclosure relating to Merge and AMVP modes in SVC for HEVC. This video coding device for scalable coding of video data having an enhancement layer and a base layer may comprise one or more processors. The one or more processors may identify a prediction unit in the base layer that is co-located with a current prediction unit in the enhancement layer, add motion information from the identified prediction unit in the base layer to a list of candidate motion information associated with the current prediction unit in the enhancement layer, and perform motion prediction based on the list of candidate motion information.

Additionally, the one or more processors may add the motion information from the identified prediction unit as a first candidate in the list of candidate motion information. The one or more processors may, in some instances, add the motion information from the identified prediction unit to the list of candidate motion information in place of temporal co-located motion information. In some instances, the list of candidate motion information does not include temporal co-located motion information and the one or more processors perform motion prediction based on the list of candidate motion information that does not include the temporal co-located motion information. As noted above, the list of candidate motion information may be formed in accordance with one of a merge mode and an advanced motion vector prediction mode. Furthermore, the one or more processors may scale the motion information of the identified prediction unit before adding the motion information to the list of candidate motion information, again as noted above.

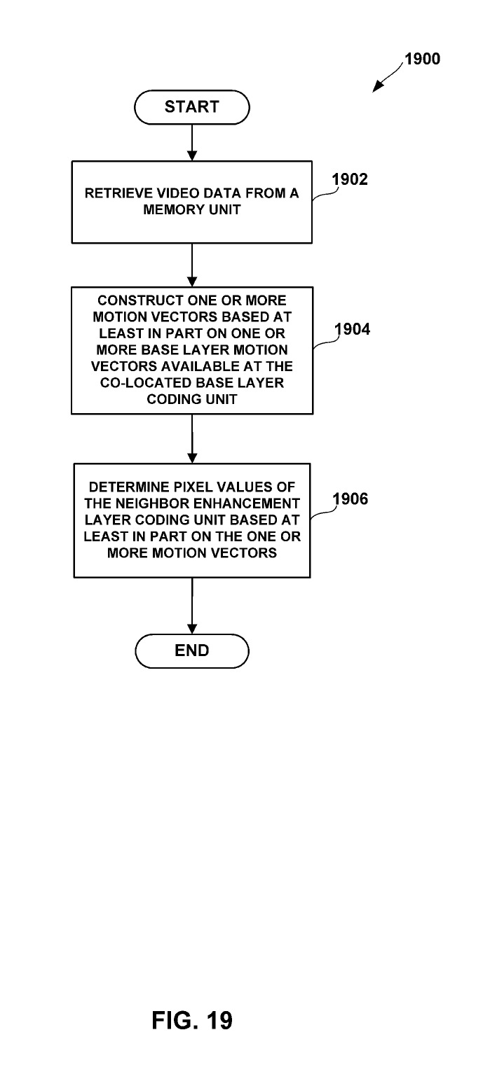

FIG. 19 illustrates an example method 1900 for coding video data. The method 1900 can be performed by one or more components of video encoder 20 or video decoder 30, for example. For example, the method 1900 can be performed by the mode select unit 40, the motion estimation unit 42 and/or the motion compensation unit 44 of the video encoder 20. As another example, the method 1900 can be performed by the entropy decoding unit 70 and/or the motion compensation unit 72 of the video decoder 30. In some embodiments, other components may be used to implement one or more of the steps described herein.

At block 1902, video data can be retrieved from a memory unit. In an embodiment, the video data comprises a base layer and an enhancement layer. The base layer may comprise a co-located base layer coding unit. The enhancement layer may comprise a first enhancement layer coding unit and a neighbor enhancement layer coding unit. The first enhancement layer coding unit may be intra-mode coded and the neighbor enhancement layer coding unit may be inter-mode coded. The first enhancement layer coding unit may neighbor the neighbor enhancement layer coding unit. In a further embodiment, the co-located base layer coding unit is located at a position in the base layer corresponding to a position of the first enhancement layer coding unit in the enhancement layer.

At block 1904, one or more motion vectors can be constructed based at least in part on one or more base layer motion vectors available at the co-located base layer coding unit. In an embodiment, the one or more motion vectors are associated with the first enhancement layer coding unit. At block 1906, pixel values of the neighbor enhancement layer coding unit can be determined based at least in part on the one or more motion vectors.

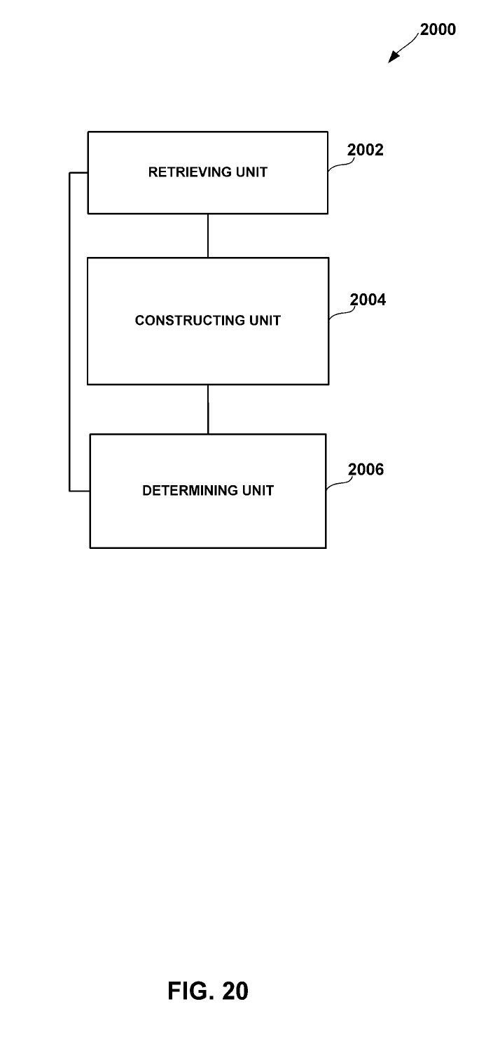

FIG. 20 is a functional block diagram of an example video coder 2000. Video coder 2000 includes retrieving unit 2002, constructing unit 2004, and determining unit 2006. One or more components of video encoder 20 or video decoder 30, for example, can be used to implement retrieving unit 2002, constructing unit 2004, and determining unit 2006. For example, retrieving unit 2002, constructing unit 2004, and determining unit 2006 can be implemented by the mode select unit 40, the motion estimation unit 42 and/or the motion compensation unit 44 of the video encoder 20. As another example, retrieving unit 2002, constructing unit 2004, and determining unit 2006 can be implemented by the entropy decoding unit 70 and/or the motion compensation unit 72 of the video decoder 30. In some embodiments, other components may be used to implement one or more of the units.

Retrieving unit 2002 can retrieve video data from a memory unit. Constructing unit 2004 can construct one or more motion vectors based at least in part on one or more base layer motion vectors available at the co-located base layer coding unit. Determining unit 2006 can determine pixel values of the neighbor enhancement layer coding unit can be determined based at least in part on the one or more motion vectors.

In some embodiments, means for retrieving video data comprises retrieving unit 2002. Further, in some embodiments, means for constructing one or more motion vectors comprises constructing unit 2004. In some embodiments, means for determining pixel values comprises determining unit 2006.

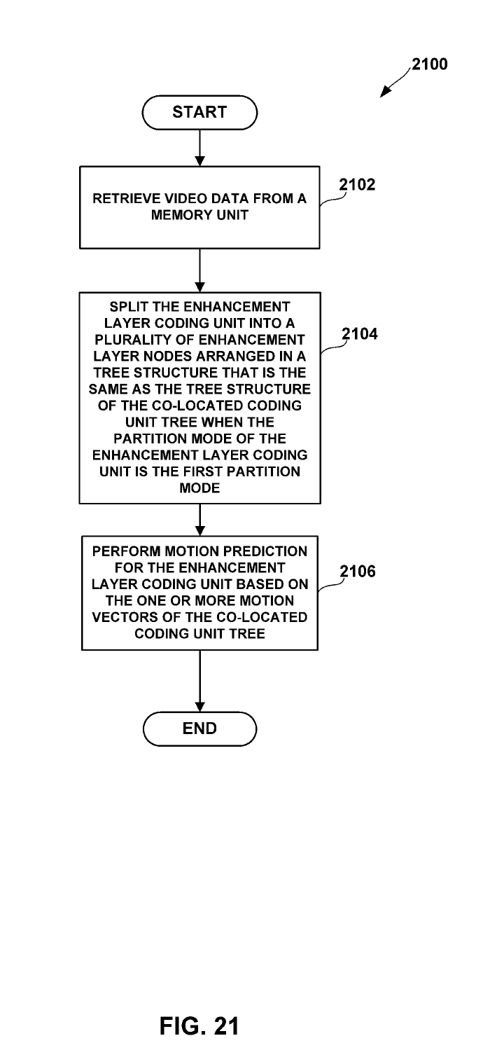

FIG. 21 illustrates another example method 2100 for coding video data. The method 2100 can be performed by one or more components of video encoder 20 or video decoder 30, for example. For example, the method 2100 can be performed by the mode select unit 40, the motion compensation unit 44, and/or the partition unit 48 of the video encoder 20. As another example, the method 2100 can be performed by the motion compensation unit 72 of the video decoder 30. In some embodiments, other components may be used to implement one or more of the steps described herein.

At block 2102, video data can be retrieved from a memory unit. In an embodiment, the video data comprises a base layer and an enhancement layer. The enhancement layer may comprise an enhancement layer coding unit. The enhancement layer coding unit may be inter-mode coded and a partition mode of the enhancement layer coding unit may be a first partition mode. The base layer may comprise a co-located coding unit tree that includes one or more motion vectors. In a further embodiment, the co-located coding unit tree is located at a position in the base layer corresponding to a position of the enhancement layer coding unit in the enhancement layer. The co-located coding unit tree may comprise a plurality of base layer nodes arranged in a tree structure.

At block 2104, the enhancement layer coding unit can be split into a plurality of enhancement layer nodes arranged in a tree structure that is the same as the tree structure of the co-located coding unit tree when the partition mode of the enhancement layer coding unit is the first partition mode. At block 2106, motion prediction for the enhancement layer coding unit can be performed based on the one or more motion vectors of the co-located coding unit tree.

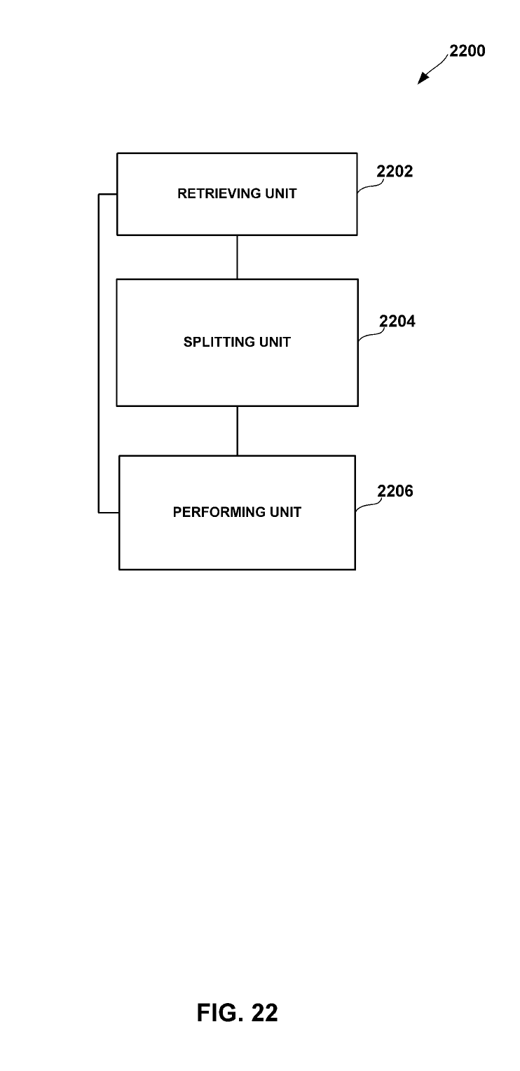

FIG. 22 is another functional block diagram of an example video coder 2200. Video coder 2200 includes retrieving unit 2202, splitting unit 2204, and performing unit 2206. One or more components of video encoder 20 or video decoder 30, for example, can be used to implement retrieving unit 2202, splitting unit 2204, and performing unit 2206. For example, retrieving unit 2202, splitting unit 2204, and performing unit 2206 can be implemented by the mode select unit 40, the motion compensation unit 44, and/or the partition unit 48 of the video encoder 20. As another example, retrieving unit 2202, splitting unit 2204, and performing unit 2206 can be implemented by the motion compensation unit 72 of the video decoder 30. In some embodiments, other components may be used to implement one or more of the units.

Retrieving unit 2202 can retrieve video data from a memory unit. Splitting unit 2204 can split the enhancement layer coding unit into a plurality of enhancement layer nodes arranged in a tree structure that is the same as the tree structure of the co-located coding unit tree when the partition mode of the enhancement layer coding unit is the first partition mode. Performing unit 2206 can perform motion prediction for the enhancement layer coding unit based on the one or more motion vectors of the co-located coding unit tree.

In some embodiments, means for retrieving video data comprises retrieving unit 2202. Further, in some embodiments, means for splitting comprises splitting unit 2204. In some embodiments, means for performing comprises performing unit 2206.

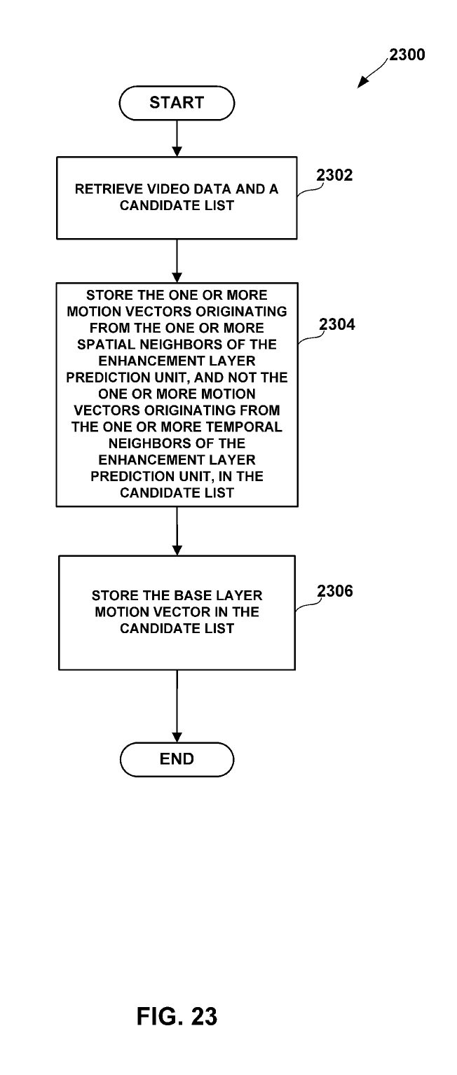

FIG. 23 illustrates another example method 2300 for coding video data. The method 2300 can be performed by one or more components of video encoder 20 or video decoder 30, for example. For example, the method 2300 can be performed by the mode select unit 40 and/or the motion estimation unit 42 of the video encoder 20. As another example, the method 2300 can be performed by the motion compensation unit 72 of the video decoder 30. In some embodiments, other components may be used to implement one or more of the steps described herein.

At block 2302, video data and a candidate list can be retrieved from a memory unit. In an embodiment, the video data comprises a base layer and an enhancement layer. The base layer may comprise a base layer prediction unit. The enhancement layer may comprise an enhancement layer prediction unit. The base layer prediction unit may include a base layer motion vector. The enhancement layer prediction unit may include one or more enhancement layer motion vectors. The one or more enhancement layer motion vectors may comprise one or more motion vectors originating from one or more spatial neighbors of the enhancement layer prediction unit and one or more vectors originating from one or more temporal neighbors of the enhancement layer prediction unit. In an embodiment, the base layer prediction unit is located at a position in the base layer corresponding to a position of the enhancement layer prediction unit in the enhancement layer. The candidate list may comprise a list of motion vectors for use by the enhancement layer prediction unit.

At block 2304, the one or more motion vectors originating from the one or more spatial neighbors of the enhancement layer prediction unit, and not the one or more motion vectors originating from the one or more temporal neighbors of the enhancement layer prediction unit, can be stored in the candidate list. At block 2306, the base layer motion vector can be stored in the candidate list.

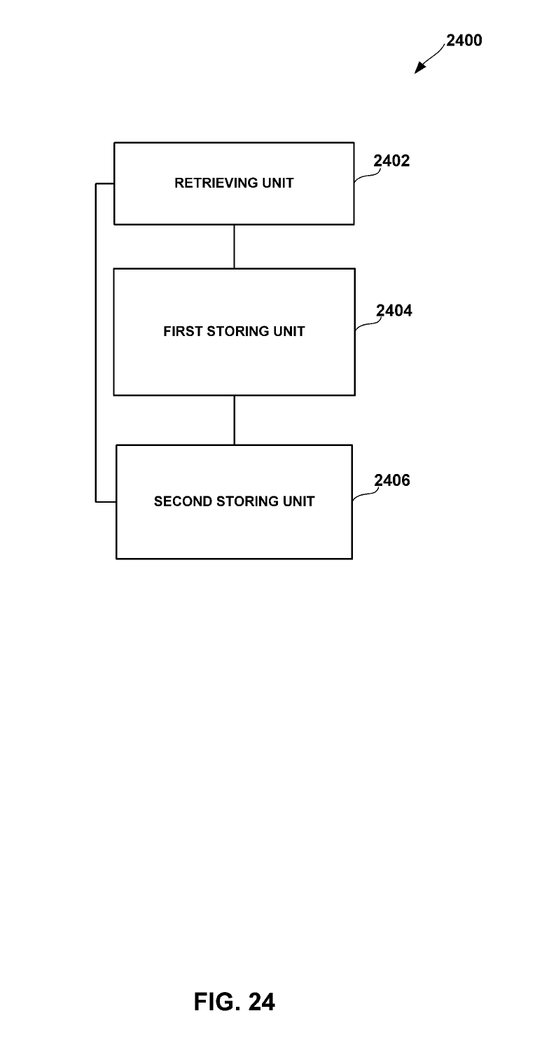

FIG. 24 is another functional block diagram of an example video coder 2400. Video coder 2400 includes retrieving unit 2402, first storing unit 2404, and second storing unit 2406. One or more components of video encoder 20 or video decoder 30, for example, can be used to implement retrieving unit 2402, first storing unit 2404, and second storing unit 2406. For example, retrieving unit 2402, first storing unit 2404, and second storing unit 2406 can be implemented by the mode select unit 40 and/or the motion estimation unit 42 of the video encoder 20. As another example, retrieving unit 2402, first storing unit 2404, and second storing unit 2406 can be implemented by the motion compensation unit 72 of the video decoder 30. In some embodiments, other components may be used to implement one or more of the units.

Retrieving unit 2402 can retrieve video data and a candidate list from a memory unit. First storing unit 2404 can store the one or more motion vectors originating from the one or more spatial neighbors of the enhancement layer prediction unit, and not the one or more motion vectors originating from the one or more temporal neighbors of the enhancement layer prediction unit, in the candidate list. Second storing unit 1306 can store the base layer motion vector in the candidate list.

In some embodiments, means for retrieving video data and a candidate list comprises retrieving unit 2402. Further, in some embodiments, means for storing the one or more motion vectors comprises first storing unit 2404. In some embodiments, means for storing the base layer motion vector comprises second storing unit 2406.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware. Various examples have been described. These and other examples are within the scope of the following claims.

What is claimed is:

1. An apparatus configured to code video data, the apparatus comprising:
a memory unit configured to store the video data, wherein the video data comprises a base layer and an enhancement layer, wherein the base layer comprises a co-located base layer coding unit, wherein the enhancement layer comprises a first enhancement layer coding unit and a neighbor enhancement layer coding unit, wherein the first enhancement layer coding unit is intra-mode coded, wherein the neighbor enhancement layer coding unit is inter-mode coded, wherein the first enhancement layer coding unit neighbors the neighbor enhancement layer coding unit, and wherein the co-located base layer coding unit is located at a position in the base layer corresponding to a position of the first enhancement layer coding unit in the enhancement layer;
a processor in communication with the memory unit, the processor configured to:
construct one or more motion vectors based at least in part on one or more base layer motion vectors available at the co-located base layer coding unit, wherein the one or more motion vectors are associated with the first enhancement layer coding unit; and
determine pixel values of the neighbor enhancement layer coding unit based at least in part on the one or more motion vectors.

2. The apparatus of claim 1, wherein the processor is further configured to scale the one or more base layer motion vectors to construct the one or more motion vectors.

3. The apparatus of claim 1, wherein the first enhancement layer coding unit is one of a spatial neighbor or a temporal neighbor of the neighbor enhancement layer coding unit.

4. The apparatus of claim 1, wherein the apparatus further comprises a motion compensation unit in communication with the processor, wherein the motion compensation unit is further configured to receive a syntax element extracted from a bit stream that signals that a texture of the first enhancement layer coding unit is predicted from a reconstructed texture of the co-located base layer coding unit and that the one or more motion vectors are constructed based at least in part on the one or more base layer motion vectors.

5. The apparatus of claim 1, wherein the base layer comprises a slice, and wherein the slice comprises the co-located base layer coding unit and one or more other base layer coding units.

6. The apparatus of claim 5, further comprising a motion compensation unit in communication with the processor, wherein the motion compensation unit is further configured to receive a syntax element extracted from a portion of a bit stream that corresponds to a header of the slice that signals that the reconstructed texture of the co-located base layer coding unit and reconstructed textures of the one or more other base layer coding units are used to predict textures of the first enhancement layer coding unit and one or more other enhancement layer coding units, wherein the syntax element further signals that motion vectors of the first enhancement layer coding unit and the one or more other enhancement layer coding units are constructed based at least in part on motion vectors available at the co-located base layer coding unit and the one or more other base layer coding units.

7. The apparatus of claim 1, wherein the processor comprises a motion estimation unit and a motion compensation unit of a video encoder.

8. The apparatus of claim 1, wherein the processor comprises an entropy decoding unit and a motion compensation unit of a video decoder.

9. A method of coding video data, comprising:
retrieving video data from a memory unit, wherein the video data comprises a base layer and an enhancement layer, wherein the base layer comprises a co-located base layer coding unit, wherein the enhancement layer comprises a first enhancement layer coding unit and a neighbor enhancement layer coding unit, wherein the first enhancement layer coding unit is intra-mode coded, wherein the neighbor enhancement layer coding unit is inter-mode coded, wherein the first enhancement layer coding unit neighbors the neighbor enhancement layer coding unit, and wherein the co-located base layer coding unit is located at a position in the base layer corresponding to a position of the first enhancement layer coding unit in the enhancement layer;
constructing one or more motion vectors based at least in part on one or more base layer motion vectors available at the co-located base layer coding unit, wherein the one or more motion vectors are associated with the first enhancement layer coding unit; and
determining pixel values of the neighbor enhancement layer coding unit based at least in part on the one or more motion vectors.

10. The method of claim 9, further comprising scaling, by a motion compensation unit of a video encoder, the one or more base layer motion vectors to construct the one or more motion vectors.

11. The method of claim 9, wherein the first enhancement layer coding unit is one of a spatial neighbor or a temporal neighbor of the neighbor enhancement layer coding unit.

12. The method of claim 9, further comprising receiving, by a motion compensation unit of a video decoder, a syntax element extracted from a bit stream that signals that a texture of the first enhancement layer coding unit is predicted from a reconstructed texture of the co-located base layer coding unit and that the one or more motion vectors are constructed based at least in part on the one or more base layer motion vectors.

13. The method of claim 9, wherein the base layer comprises a slice, and wherein the slice comprises the co-located base layer coding unit and one or more other base layer coding units.

14. The method of claim 13, further comprising receiving, by a motion compensation unit of a video decoder, a syntax element extracted from a portion of a bit stream that corresponds to a header of the slice that signals that the reconstructed texture of the co-located base layer coding unit and reconstructed textures of the one or more other base layer coding units are used to predict textures of the first enhancement layer coding unit and one or more other enhancement layer coding units, wherein the syntax element further signals that motion vectors of the first enhancement layer coding unit and the one or more other enhancement layer coding units are constructed based at least in part on motion vectors available at the co-located base layer coding unit and the one or more other base layer coding units.

15. An apparatus for coding video data, comprising;
means for retrieving video data from a memory unit, wherein the video data comprises a base layer and an enhancement layer, wherein the base layer comprises a co-located base layer coding unit, wherein the enhancement layer comprises a first enhancement layer coding unit and a neighbor enhancement layer coding unit, wherein the first enhancement layer coding unit is intra-mode coded, wherein the neighbor enhancement layer coding unit is inter-mode coded, wherein the first enhancement layer coding unit neighbors the neighbor enhancement layer coding unit, and wherein the co-located base layer coding unit is located at a position in the base layer corresponding to a position of the first enhancement layer coding unit in the enhancement layer;
means for constructing one or more motion vectors based at least in part on one or more base layer motion vectors available at the co-located base layer coding unit, wherein the one or more motion vectors are associated with the first enhancement layer coding unit; and
means for determining pixel values of the neighbor enhancement layer coding unit based at least in part on the one or more motion vectors.

16. The apparatus of claim 15, further comprising means for scaling the one or more base layer motion vectors to construct the one or more motion vectors.

17. The apparatus of claim 15, wherein the first enhancement layer coding unit is one of a spatial neighbor or a temporal neighbor of the neighbor enhancement layer coding unit.

18. The method of claim 15, further comprising means for receiving a syntax element extracted from a bit stream that signals that a texture of the first enhancement layer coding unit is predicted from a reconstructed texture of the co-located base layer coding unit and that the one or more motion vectors are constructed based at least in part on the one or more base layer motion vectors.

19. The apparatus of claim 15, wherein the base layer comprises a slice, and wherein the slice comprises the co-located base layer coding unit and one or more other base layer coding units.

20. The apparatus of claim 19, further comprising means for receiving a syntax element extracted from a portion of a bit stream that corresponds to a header of the slice that signals that the reconstructed texture of the co-located base layer coding unit and reconstructed textures of the one or more other base layer coding units are used to predict textures of the first enhancement layer coding unit and one or more other enhancement layer coding units, wherein the syntax element further signals that motion vectors of the first enhancement layer coding unit and the one or more other enhancement layer coding units are constructed based at least in part on motion vectors available at the co-located base layer coding unit and the one or more other base layer coding units.

21. The apparatus of claim 15, wherein the means for retrieving video data comprises a mode select unit of a video encoder, wherein the means for constructing comprises a motion estimation unit of the video encoder, and wherein the means for determining comprises a motion compensation unit of the video encoder.

22. The apparatus of claim 15, wherein the means for retrieving video data and the means for determining comprise a motion compensation unit of a video decoder, and wherein the means for constructing comprises an entropy decoding unit of the video decoder.

23. A non-transitory computer-readable medium comprising code that, when executed, causes an apparatus to:
retrieve video data from a memory unit, wherein the video data comprises a base layer and an enhancement layer, wherein the base layer comprises a co-located base layer coding unit, wherein the enhancement layer comprises a first enhancement layer coding unit and a neighbor enhancement layer coding unit, wherein the first enhancement layer coding unit is intra-mode coded, wherein the neighbor enhancement layer coding unit is inter-mode coded, wherein the first enhancement layer coding unit neighbors the neighbor enhancement layer coding unit, and wherein the co-located base layer coding unit is located at a position in the base layer corresponding to a position of the first enhancement layer coding unit in the enhancement layer;
construct one or more motion vectors based at least in part on one or more base layer motion vectors available at the co-located base layer coding unit, wherein the one or more motion vectors are associated with the first enhancement layer coding unit; and
determine pixel values of the neighbor enhancement layer coding unit based at least in part on the one or more motion vectors.

24. The medium of claim 23, further comprising code that, when executed, causes the apparatus to scale the one or more base layer motion vectors to construct the one or more motion vectors.

25. The medium of claim 23, wherein the first enhancement layer coding unit is one of a spatial neighbor or a temporal neighbor of the neighbor enhancement layer coding unit.

26. The medium of claim 23, further comprising code that, when executed, causes an apparatus to receive a syntax element extracted from a bit stream that signals that a texture of the first enhancement layer coding unit is predicted from a reconstructed texture of the co-located base layer coding unit and that the one or more motion vectors are constructed based at least in part on the one or more base layer motion vectors.

27. The medium of claim 23, wherein the base layer comprises a slice, and wherein the slice comprises the co-located base layer coding unit and one or more other base layer coding units.

28. The medium of claim 27, further comprising code that, when executed, causes an apparatus to receive a syntax element extracted from a portion of a bit stream that corresponds to a header of the slice that signals that the reconstructed texture of the co-located base layer coding unit and reconstructed textures of the one or more other base layer coding units are used to predict textures of the first enhancement layer coding unit and one or more other enhancement layer coding units, wherein the syntax element further signals that motion vectors of the first enhancement layer coding unit and the one or more other enhancement layer coding units are constructed based at least in part on motion vectors available at the co-located base layer coding unit and the one or more other base layer coding units.
